(19) United States
(12) Patent Application Publication
(10) Pub. No.: US 2010/0235640 A1
(43) Pub. Date: Sep. 16, 2010

(54) INFORMATION PROCESSING APPARATUS, METHOD OF MUTUAL AUTHENTICATION, MUTUAL AUTHENTICATION PROGRAM, AND STORAGE MEDIUM

(76) Inventor: Jun Satoh, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/722,977

(22) Filed: Mar. 12, 2010

(30) Foreign Application Priority Data
Mar. 16, 2009 (JP) 2009-062210
May 21, 2009 (JP) 2009-123010
Dec. 25, 2009 (JP) 2009-293673

(51) Int. Cl. H04L 9/32

(52) U.S. Cl. 713/169; 713/175

(57) ABSTRACT

An information processing apparatus and a counterpart apparatus supporting data communications are devised. The information processing apparatus is connected to the counterpart apparatus via a communication network. The information processing apparatus and the counterpart apparatus supporting data communications use mutual authentication using a certificate file. The information processing apparatus includes a certificate management unit, a verification information obtaining unit, and a security key generation unit. The certificate management unit encrypts and decrypts the certificate file using a security key. The verification information obtaining unit obtains verification information of the information processing apparatus. The verification information enables identification of the information processing apparatus as a unique physical entity. The security key generation unit generates the security key by conducting a non-reversible transformation of the verification information obtained by the verification information obtaining unit. The verification information is used as source data.

### CROSS-REFERENCE TO RELATED APPLICATIONS

This application claims priority to Japanese Patent Application Nos. 2009-062210, filed on Mar. 16, 2009, 2009-123010, filed on May 21, 2009, and 2009-293673, filed on Dec. 25, 2009 in the Japan Patent Office, which are hereby incorporated by reference herein in their entirety.

### BACKGROUND OF THE INVENTION

1. Field of the Invention

The present invention relates to an information processing apparatus, a method of mutual authentication, mutual authentication program, and storage medium, and more particularly, to an information processing apparatus capable of data communications based on mutual authentication, a method of mutual authentication, a mutual authentication program, and a storage medium storing the mutual authentication program.

2. Description of the Background Art

With the diffusion of networks such as the Internet, data communications can now be conducted using wired- and/or wireless-type networks. Such network-based data communications require protection from tampering such as data falsification, spoofing, or the like.

Typically, an image processing apparatus located at an end-user site is connected to a management-purpose information processing apparatus located at a vendor site (e.g., manufacturer of apparatus, maintenance service provider, etc.) via a network such as the Internet. The end-user site may be a business office, which may use copiers, printers, facsimiles, and multi-functional peripherals such as image processing apparatuses. The vendor site may include management-purpose information processing apparatuses to monitor image processing apparatuses located at end-user sites via the Internet. Specifically, in such a configuration, an image processing apparatus at an end-user site and a management-purpose information processing apparatus may communicate data used for managing the image processing apparatus. Because the management-purpose information processing apparatus may be located remotely from the end-user site, such configurations may be termed remote monitoring systems, which monitor the image processing apparatus remotely and provide services such as maintenance at predetermined regular intervals or under certain specific circumstances.

As for the configuration of such remote monitoring systems, in one example, a management-purpose information processing apparatus is directly connected to image processing apparatuses located at end-user sites via a network, in which each of several user sites may have one or more image processing apparatuses. The management-purpose information processing apparatus collects apparatus management information, such as apparatus monitoring information, from each of the image processing apparatuses to monitor apparatuses directly and remotely.

In another example, each of one or more user sites has a plurality of image processing apparatuses and a user-side management-purpose information processing apparatus (e.g., a computer). Such user-side management-purpose information processing apparatuses may be connected to a management-purpose information processing apparatus at a vendor side via a network. In one user site, the user-side management-purpose information processing apparatus collects apparatus management information, such as apparatus monitoring information, from the plurality of image processing apparatuses, and then transmits the collected information to the vendor-side management-purpose information processing apparatus. Further, the vendor-side management-purpose information processing apparatus transmits data to the user-side management-purpose information processing apparatus, and then the user-side management-purpose information processing apparatus transfers such data to the image processing apparatuses.

Such remote monitoring/management systems may need to communicate classified information such as service fee data, user personal data, or the like, as management data. Accordingly, it is necessary to prevent tampering with such data such as data falsification and/or spoofing.

Typically, such remote monitoring/management systems employ encryption to prevent such data falsification and/or spoofing. For example, image processing apparatuses at user sites or user-side management-purpose information processing apparatuses may communicate with a vendor-side management-purpose information processing apparatus by employing a mutual authentication process using encryption such as secure socket layer (SSL), for example.

Such SSL communication for remote monitoring systems may employ an encryption system such as a private/public key system for data communications. For example, a vendor-side management-purpose information processing apparatus keeps a private key, and a user-side management-purpose information processing apparatus or an image processing apparatus at the user site keeps a public key. Further, the vendor-side apparatus and the user-side apparatus use a common key certificate encrypted by a common secret key issued by a certificate authority to verify the identity of a data-transmission sender. With such a configuration, tampering such as data falsification and/or spoofing can be prevented, and data security can be enhanced.

JP-2004-320715-A discloses a system to enhance data security further, in which a certificate obtaining unit is installed in each information processing apparatus at the factory before shipment and verification information is set in the information processing apparatuses to identify the certificate obtaining unit installed in each of the information processing apparatuses. When such information processing apparatuses communicate with other apparatuses such as a management server or the like, the image processing apparatus may transmit the verification information and a digital certificate issue request to a certificate management unit, and the certificate management unit transmits a digital certificate including the verification information to the certificate obtaining unit in response to such request. A digital certificate can be prepared from the verification information stored in the information processing apparatus. Such verification information that cannot be physically retrieved from the information processing apparatus further enhances the uniqueness and security of the private key.

The above-described method is applicable to units or apparatuses in which verification information is installed, and can enhance security of communications. However, the method is not applicable to units or apparatuses (e.g., image forming apparatuses, image scanners, etc.) that such verification information is not installed in advance. In such a situation, the security of communications and user-friendliness and utility of data may not be enhanced effectively.

Further, when a program is stored in hardware of information processing apparatuses, it becomes harder to obtain a secured certificate security compared to set verification information that can identify an apparatus physically and definitely, such as apparatus type information, apparatus serial number information, or the like, and verification information written in a specific area of a flash read-only memory (ROM) at a designated address. As such, achieving enhanced security while maintaining the user-friendliness and the utility of the data remains problematic.

Further, in information processing systems that include an image processing apparatuses and management apparatuses, the image processing apparatuses and management apparatuses may use mutual authentication using secure socket layer (SSL) as security for communications. Security of such mutual authentication can be improved by setting a longer key length for the public key used for digital certificate issuance. Using a longer public key requires that the information processing system have a certificate authority (CA) that can issue a digital certificate using the longer public key, which is different from a certificate authority CA that issues a digital certificate using a shorter public key having a shorter key length. However, if the same system includes different information processing apparatuses using different certificates having different security levels, it may become difficult to implement a stronger security configuration while at the same time maintaining downward compatibility of communications between apparatuses. For example, when one image processing apparatus uses a certificate issued using a key having a shorter key length, and the other image processing apparatuses use a certificate issued using other key having a longer key length, security of communication between apparatuses may not be greatly enhanced, for the following reasons.

First, it is hard to determine which image processing apparatus is assigned to which certificate authority as an access destination when updating the certificates. Second, when one image processing apparatus has a first certificate issued by a first certificate authority, and retains (or stores) such certificate in the apparatus, and when such first certificate is updated to a second certificate issued by a second certificate authority, the image processing apparatus may need to access the second certificate authority. However, certificate authority information set in the image processing apparatus cannot be automatically switched from the first certificate authority to the second certificate authority that issues the second certificate.

### SUMMARY

In one aspect of the invention, an information processing apparatus and a counterpart apparatus supporting data communications are devised. The information processing apparatus is connected to a counterpart apparatus via a communication network. The information processing apparatus and the counterpart apparatus supporting data communications use mutual authentication using a certificate file. The information processing apparatus includes a certificate management unit, a verification information obtaining unit, and a security key generation unit. The certificate management unit encrypts and decrypts the certificate file using a security key. The verification information obtaining unit obtains verification information of the information processing apparatus. The verification information enables identification of the information processing apparatus as a unique physical entity. The security key generation unit generates the security key by conducting a non-reversible transformation of the verification information obtained by the verification information obtaining unit. The verification information is used as source data.

In another aspect of the invention, a method of mutual authentication between an information processing apparatus and a counterpart apparatus connected to each other via a communication network is devised. The information processing apparatus and the counterpart apparatus supporting data communications use mutual authentication using a certificate file. The method comprising a certificate management step, a verification information obtaining step, and a security key generation step. The certificate management step encrypts and decrypts the certificate file using a security key. The verification information obtaining step obtains verification information of the information processing apparatus. The verification information enables identification of the information processing apparatus as a unique physical entity. The security key generation step generates the security key by conducting a non-reversible transformation of the verification information obtained by the verification information obtaining step. The verification information is used as source data.

In another aspect of the invention, an information processing system is devised. The information processing system includes one or more information processing apparatuses, one or more certificate authorities, and one or more management apparatuses. Each of the one or more information processing apparatuses, having apparatus type/serial number information, includes a communication unit that can transmit a digital certificate updating request with the apparatus type/serial number information. The one or more information processing apparatuses are disposable in the information processing system and each of the information processing apparatuses having unique apparatus type/serial number information. Each of the one or more certificate authorities issues a digital certificate. The one or more of the certificate authorities are disposable in the information processing system and each of the certificate authorities has unique access destination information. The one or more management apparatuses monitor the one or more information processing apparatuses. The one or more management apparatuses store map information correlating the apparatus type/serial number information of the one or more information processing apparatuses and the access destination information of the one or more certificate authorities for each of the information processing apparatuses and each of the certificate authorities. The one or more management apparatuses are disposable in the information processing system and each of the management apparatuses having unique access destination information. The information processing apparatuses includes an updating unit to update digital certificate information and corresponding access destination information of management apparatus stored in the information processing apparatuses. One of the one or more information processing apparatuses is monitored by a first management apparatus having a first access destination information and uses a first digital certificate issued by a first certificate authority for secure communications. The first management apparatus and the first certificate authority are set to use together. When the information processing apparatuses issues a digital certificate issue request to the first management apparatus to request an issuance of a second digital certificate for the information processing apparatuses, the information processing apparatuses receives the second digital certificate, issued by a second certificate authority, and second access destination information, set for a second management apparatus, via the first management apparatus when the digital certificate issue request is correctly executed by the first management apparatus and the second certificate authority. The second management apparatus and the second certificate authority are set to use together. The updating unit of the information processing apparatuses updates the first digital certificate and the first access destination information of the first management apparatus stored in the information processing apparatuses to the second digital certificate and the second access destination information of the second management apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an example system configuration for an apparatus monitoring system according to a first example embodiment;

FIG. 2 is one example of discrete certification package;

FIG. 3 is an example block diagram for information processing apparatus;

FIG. 4 is an example functional block diagram for information processing apparatus;

FIG. 5 is a flowchart of registration process of certificate file;

FIG. 6 is a flowchart of reading-out process of certificate file;

FIG. 7 is a sequential chart for verification process using a discrete certification package and SSL;

FIG. 8 is an example system configuration of apparatus monitoring system for information processing apparatus according to a second example embodiment;

FIG. 9 is an example block diagram for information processing apparatus of FIG. 8;

FIGS. 10A, 10B 10C, and 10D are example functional block diagrams for management apparatuses and certificate authorities of FIG. 8;

FIG. 11 illustrates a control unit and a non-volatile memory of information processing apparatus of FIG. 9;

FIGS. 12A and 12B are example functional block diagrams for control unit and storage of management apparatuses of FIG. 10;

FIGS. 13A and 13B are example functional block diagrams for control unit and storage of certificate authorities of FIG. 10;

FIG. 14 is example map information, which retains or stores data;

FIG. 15 is a flowchart for updating process of digital certificate;

FIG. 16 is a flowchart for updating process of map information;

FIG. 17 is an one example of discrete certification package; and

FIG. 18 is a sequential chart for verifying an information processing apparatus by a management apparatus using a discrete certification package and SSL.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, Operations, elements, and/or components, but do not preclude the presence or addition of one or more other features, integers, steps, Operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner.

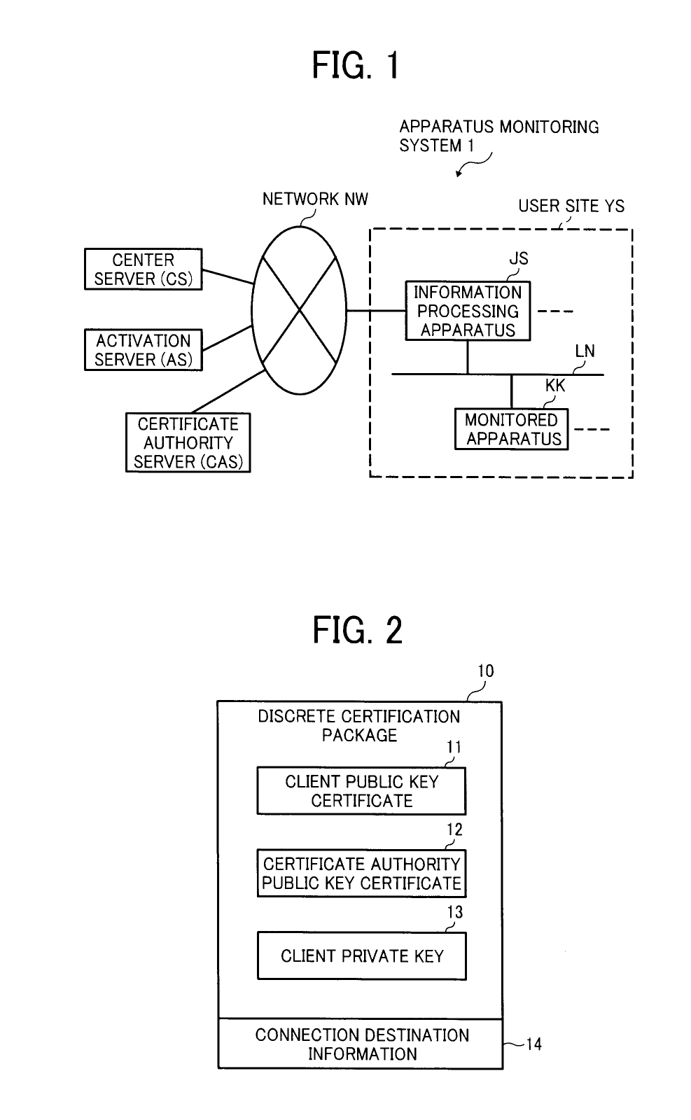

Referring now to the drawings, an apparatus monitoring system, an information processing apparatus according to a first example embodiment are described. FIGS. 1 to 7 illustrate one example of information processing apparatus or system, information verification method, information verification program, and storage medium according to a first example embodiment.

FIG. 1 illustrates an example system configuration for an apparatus monitoring system 1, in which an information processing apparatus, information verification method, information verification program, and a storage medium according to a first example embodiment may be employed.

As illustrated in FIG. 1, the apparatus monitoring system 1 may include a center server CS, an activation server AS, a certificate authority server CAS (CAS), and one or more user sites YU (FIG. 1 illustrates one YU), which are connected to each other via a network NW such as wired-type network or wireless-type network (e.g., the Internet). In the user site YU, an information processing apparatus JS and one or more apparatuses (e.g., image processing apparatus) may be connected to each other using a wired-type network such as local area network (LAN) or a wireless-type network such as local network LN. Such one or more apparatuses may be referred to as “monitored apparatus KK” because such apparatus may be motioned for its operation status or the like. The monitored apparatus KK may be an image processing apparatus such as a multi-functional peripherals (MFP), facsimiles, copiers, printers, or image scanners, and computers, for example. In the apparatus monitoring system 1, the center server CS may be used as management server (or management apparatus) that may conduct an apparatus monitoring/managing service for the monitored apparatus KK such as monitoring/managing malfunction status, consumable supplies status, or the like for the monitored apparatus KK.

In the user site YU, the information processing apparatus JS may communicate signals, information, or data with the monitored apparatus KK via the local network LN to collect apparatus management information such as apparatus monitoring information or data of the monitored apparatus KK such as for example operation status, remaining amount of consumable supplies, malfunction information of monitored apparatus KK. Further, the information processing apparatus JS may transmit the apparatus management information such as apparatus monitoring information to the center server CS using encryption communication (for example, SSL communication), which may be used for mutual authentication to be described later. In such encryption communication for mutual authentication, the information processing apparatus JS may use a discrete certification package 10 illustrated in FIG. 2, wherein the certificate authority server CAS issues the discrete certification package, and the center server CS may be set as a connection destination for the information processing apparatus JS by the discrete certification package 10, for example.

When the discrete certification package 10 is to be used, the center server CS function as intermediary between the information processing apparatus JS and the certificate authority server CAS.

Specifically, the center server CS may function as below. When to conduct an encryption communication for mutual authentication with the center server CS, the information processing apparatus JS may request an issuance of the discrete certification package 10 (see FIG. 2) to the center server CS, wherein the center server CS may be used as a counterpart apparatus of the information processing apparatus JS (or a connection destination of the information processing apparatus JS). Upon receiving a request from the information processing apparatus JS, the center server CS requests the certificate authority server CAS to issue the discrete certification package 10 for each of the information processing apparatus JS. Then, based on the request from center server CS, the certificate authority server CAS issues the discrete certification package 10 (see FIG. 2) to the center server CS. The center server CS transfers the discrete certification package 10 issued by the certificate authority server CAS to the information processing apparatus JS that has requested an issuance of the discrete certification package.

In an example embodiment, the discrete certification package 10 may be a digital certificate package using public key cryptography standards (PKCS), for example. As illustrated in FIG. 2, the discrete certification package 10 may include a client public key certificate 11, a certificate authority public key certificate 12 (CA public key certificate 12), a client private key 13, and connection destination information 14, for example. The client public key certificate 11 and the client private key 13 may be respectively used as a public key certificate and a private key for the information processing apparatus JS when the information processing apparatus JS and the center server CS conducts an encryption communication for mutual authentication. The CA public key certificate 12 may be used as a public key certificate for the certificate authority server CAS. The connection destination information 14 may be verification information of a connection destination, which may be used for an encryption communication for mutual authentication using the discrete certification package 10. In example embodiment, the connection destination information 14 may be an Internet protocol address (IP address), or the like of the center server CS, for example, but not limited thereto.

The center server CS may be a server such as management server located in a service vendor, which provides given services for the monitored apparatus KK located in the user site YU. The service vendor may provide apparatus monitoring/managing service for the monitored apparatus KK such as for example a maintenance service, a malfunction repairing service, a consumable supplies management, and monitoring of counter value of several counters. The service vendor may be a manufacturer of the monitored apparatus KK, a maintenance service company, or the like. The center server CS may receive the above-mentioned apparatus management information such as apparatus monitoring information from the information processing apparatus JS located in the user site YU using the encryption communication for mutual authentication. The center server CS may accumulate and manage the above-mentioned apparatus management information such as apparatus monitoring information, and provide the above-mentioned apparatus monitoring/managing service.

Further, the information processing apparatus JS may collect and transfer apparatus management information such as apparatus monitoring information to the center server CS by implementing an apparatus information notification program 40 (see FIG. 4), for example.

The activation server AS may conduct an activation of the above mentioned encryption communication for mutual authentication, in which it is checked whether an authorized license is given (i.e., verification of license). Specifically, the activation server AS may conduct a verification process of the apparatus information notification program 40 employed for the information processing apparatus JS to check license verification of the apparatus information notification program 40.

The certificate authority server CAS issues the discrete certification package 10, for example. In an example embodiment, the certificate authority server CAS may function with the activation server AS to secure “uniqueness” of the discrete certification package 10, and prevent an issuance of a discrete certification package to an information processing apparatus used by a client having no licensee-verification or licensee-authority.

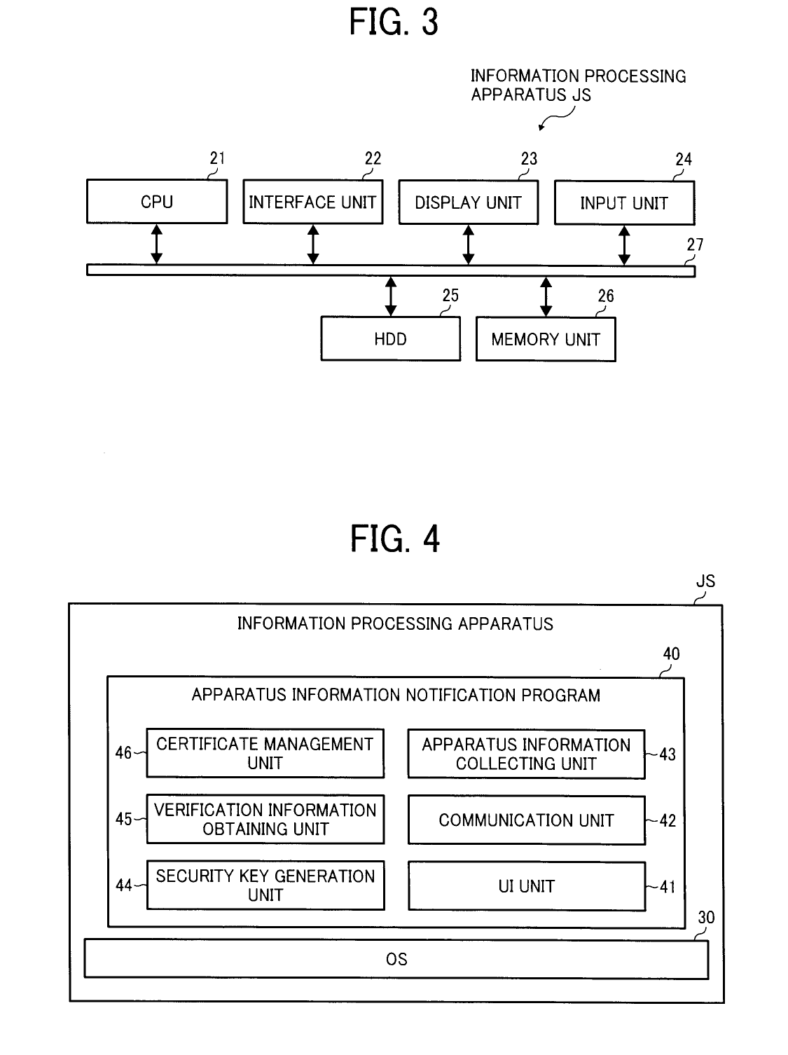

The information processing apparatus JS may be a server, a personal computer, or the like employing a typical hardware configuration. As illustrated in FIG. 3, the information processing apparatus JS may include a central processing unit 21 (CPU 21), an interface unit 22, a display unit 23, an input unit 24, a hard disk drive 25 (HDD 25), a memory unit 26, and a bus 27 for example. The bus 27 may be used to connect such units with each other.

The HDD 25 may store an operating system (OS) 30 (see FIG. 4), various programs required for the information processing apparatus JS. For example, the HDD 25 may store the apparatus information notification program 40 (see FIG. 4), which implements apparatus information notification processing used with a mutual authentication process or method in example embodiment. Further the HDD 25 may conduct data accumulation, data deletion, and data edition under a control of the CPU 21.

The memory unit 26 may be configured with read only memory (ROM), a random access memory (RAM) or the like, and may a store system program or system data in advance. When the program stored in the HDD 25 is activated or executed, the CPU 21 reads out the program from the HDD 25, and loads the program in the memory unit 26 to execute the program.

As above described, the CPU 21 executes various programs using the OS stored in the HDD 25 to control each of units in the information processing apparatus JS so that the information processing apparatus JS can execute its intended functions or processing. Further, the CPU 21 may execute the apparatus information notification program 40 to implement apparatus information notification processing used with a mutual authentication method in example embodiments.

The interface unit 22 may be used as an interface connectable to the network NW and the local network LN, for example. Under a control of the CPU 21, the interface unit 22 may provide a communication connection function between the information processing apparatus JS and one or more apparatuses disposed on the network NW. For example, the interface unit 22 may provide a communication connection function between the information processing apparatus JS and other apparatus such as the center server CS, the activation server AS, and the certificate authority server CAS via the network NW. Further, the interface unit 22 may be used as an interface to connect the information processing apparatus JS and the monitored apparatus KK on the local network LN, by which the information processing apparatus JS can collect apparatus management information such as apparatus monitoring information from the monitored apparatus KK.

The display unit 23 may be a cathode ray tube (CRT), a liquid crystal display (LCD), or the like. Under a control of the CPU 21, the display unit 23 may display a screen used for inputting information. For example, when the apparatus information notification program 40 is executed, the display unit 23 may display a GUI (graphical user interface) for inputting a key used for verification.

The input unit 24 may be an input device such as for example a keyboard, a mouse, or the like. The input unit 24 may be used to input information to the information processing apparatus JS. Such information may be a command instruction to instruct the information processing apparatus JS to conduct given processes. For example, the input unit 24 may be used to input a key used for verification key when an apparatus information notification processing is conducted.

The information processing apparatus JS may conduct a given information processing such as apparatus information notification processing using the apparatus information notification program 40 stored in a storage medium, which is readable by a computer. The storage medium may be ROM, electrically erasable and programmable read only memory (EEPROM), erasable programmable ROM (EPROM), flash memory, flexible disk, compact disc read only memory (CD-ROM), compact disc rewritable (CD-RW), digital video disk (DVD), secure digital (SD) card, magneto-optical disc (MO), and or the like. Such storage medium may be used as the memory unit 26.

The apparatus information notification program 40, which is used to implement an apparatus information notification processing, is used with a mutual authentication method in an example embodiment. The apparatus information notification program 40 may be read from the memory unit 26 and loaded in the HDD 25, or may be received via the network NW and loaded in the HDD 25. With such setting, the information processing apparatus JS can implement apparatus information notification processing, to be described later, used with a mutual authentication method. The apparatus information notification program 40, which is a computer executable program, may be described with any languages such as legacy programming language or object-oriented programming language such as assembler, C, C++, C#, Java (registered trademark). The apparatus information notification program 40, stored in the above-described storage medium, can be distributed to a given apparatus or the like.

When the apparatus information notification program 40 is loaded in the information processing apparatus JS and executed on the OS 30, a functional configuration illustrated in FIG. 4 can be devised in the information processing apparatus JS. As illustrated in FIG. 4, a user interface (UI) unit 41, a communication unit 42, an apparatus information collecting unit 43, a security key generation unit 44, a verification information obtaining unit 45, and a certificate management unit 46 may be configured in the information processing apparatus JS.

The UI unit 41 may instruct the display unit 23 to display a graphical user interface (GUI), detect a user request, and provide information to a user.

The apparatus information collecting unit 43 may collect apparatus management information such as apparatus monitoring information from the monitored apparatus KK connected to the local network LN.

The communication unit 42 may request an activation of the apparatus information notification program 40 to the activation server AS; request issuance of the discrete certification package 10 to the center server CS based on an activation result; and transfer collected apparatus management information such as apparatus monitoring information to the center server CS. In such process, the communication unit 42 may conduct an encryption communication for a mutual authentication using the discrete certification package 10. Further, the communication unit 42 may communicate with the center server CS, the activation server AS, and the certificate authority server CAS using verification information (e.g., IP address, host name, URL, or the like) of the center server CS, the activation server AS, and the certificate authority server CAS, wherein such verification information may be stored in a storage readable by using the apparatus information notification program 40 loaded in the HDD 25.

The certificate management unit 46 may be used to register the discrete certification package 10 in the HDD 25, and to read out the discrete certification package 10 from the HDD 25. When the discrete certification package 10 is registered to the HDD 25, the certificate management unit 46 encrypts the discrete certification package 10, and when the discrete certification package 10 is read from the HDD 25, the certificate management unit 46 decrypts the discrete certification package 10.

The verification information obtaining unit 45 may obtain verification information of the information processing apparatus JS. Such verification information of the information processing apparatus JS may be information that can identify the information processing apparatus JS as a unique physical entity. Such verification information may include a media access control (MAC) address of the information processing apparatus JS, and a serial number set for device(s) of the information processing apparatus JS (e.g., serial number of CPU 21 and memory unit 26), but not limited thereto. Such information can be used as unique information attached to each one of apparatuses permanently, which means such unique information may not be detached from the apparatus. Further, the verification information obtaining unit 45 may use some information as a source data for generating a security key. For example, the verification information obtaining unit 45 may obtain a common password used for communicating with the center server CS. As such, the verification information obtaining unit 45 may function as a common password obtaining unit. The security key generation unit 44 may generate a security key useable for encrypting a file.

A description is now given to data communications process according to a first example embodiment. In an example embodiment, the information processing apparatus JS obtains apparatus management information such as apparatus monitoring information for the monitored apparatus KK, which is required for apparatus monitoring/managing of the monitored apparatus KK, using the apparatus information notification program 40, and then transmits apparatus management information such as apparatus monitoring information to the center server CS. When to transmit the apparatus management information such as apparatus monitoring information to the center server CS, an apparatus information notification processing may be conducted or implemented by conducting a mutual authentication process using the discrete certification package 10.

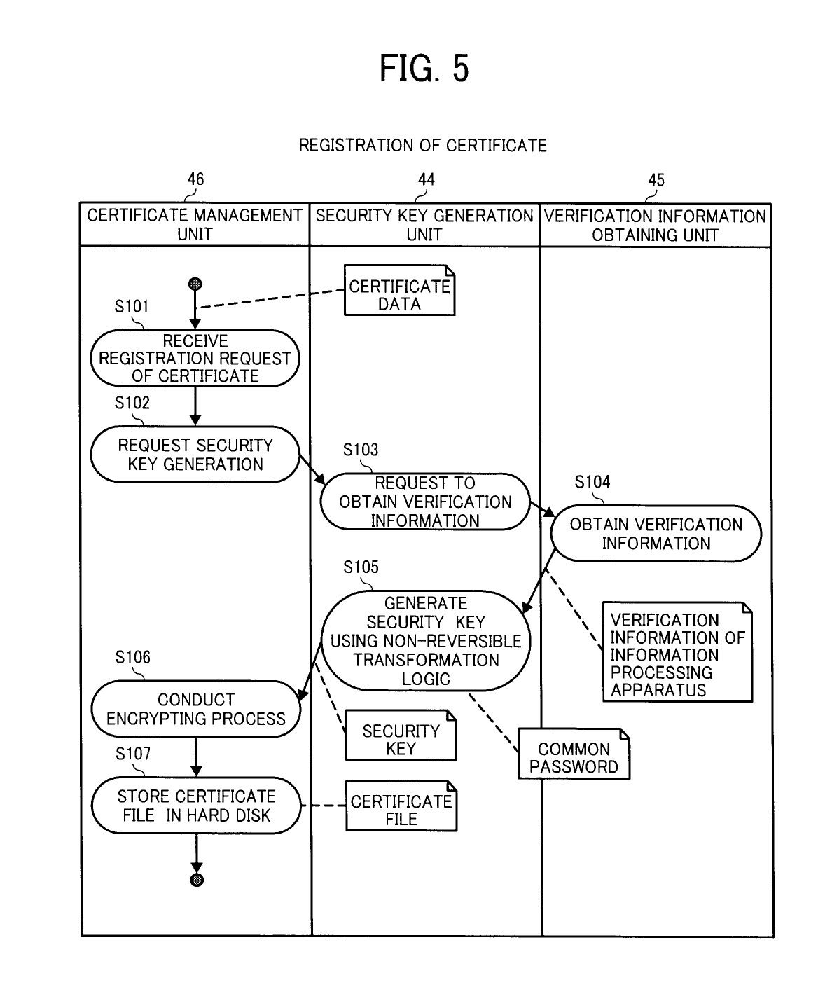

A description is given to a registration process of the discrete certification package 10 using the apparatus information notification program 40 with reference to FIG. 5.

At step S101, the certificate management unit 46 of the information processing apparatus JS receives a registration request of the discrete certification package 10. Specifically, the certificate management unit 46 receives the discrete certification package 10, issued by the certificate authority server CAS, from the center server CS by using the communication unit 42, or reads the discrete certification package 10 from a compact disc read only memory (CD-ROM).

At step S102, the certificate management unit 46 requests a security key generation to the security key generation unit 44 to generate a security key used for encrypting and decrypting the discrete certification package 10.

The security key generation unit 44 needs to obtain verification information of the information processing apparatus JS to generate the security key used for encrypting and decrypting the discrete certification package 10.

At step S103, the security key generation unit 44 requests the verification information obtaining unit 45 to obtain verification information of the information processing apparatus JS.

At step S104, the verification information obtaining unit 45 obtains verification information of the information processing apparatus JS, and transmits the obtained verification information to the security key generation unit 44.

At step S105, the security key generation unit 44 generates a security key using a non-reversible transformation logic. Specifically, after receiving the verification information of the information processing apparatus JS from the verification information obtaining unit 45, the security key generation unit 44 conducts a scramble process to the verification information, used as source data, by applying non-reversible transformation logic (e.g., hash function, SHA-2), and generates a security key, which may be referred to as non-reversible transformation.

Further, the security key generation unit 44 may generate a security key in a different manner. For example, in one case, a common password may be set for one product group, which may include various apparatuses as series product. For example, a common password may be set by installing a program to one or more apparatuses, but not limited thereto. The information processing apparatus JS may retain or store the common password prepared using a hard coding method (e.g., in security key generation unit 44), but the common password can be retained or stored by another method. The security key generation unit 44 may use the common password and verification information of the information processing apparatus JS as source data to generate a security key, wherein such method can enhance security of key.

At step S106, the security key generation unit 44 transmits the generated security key to the certificate management unit 46, and the certificate management unit 46 conducts an encrypting process for a certificate data using the received security key. At step S107, the certificate data (i.e., encrypted data) is stored in the HDD 25 as certificate file.

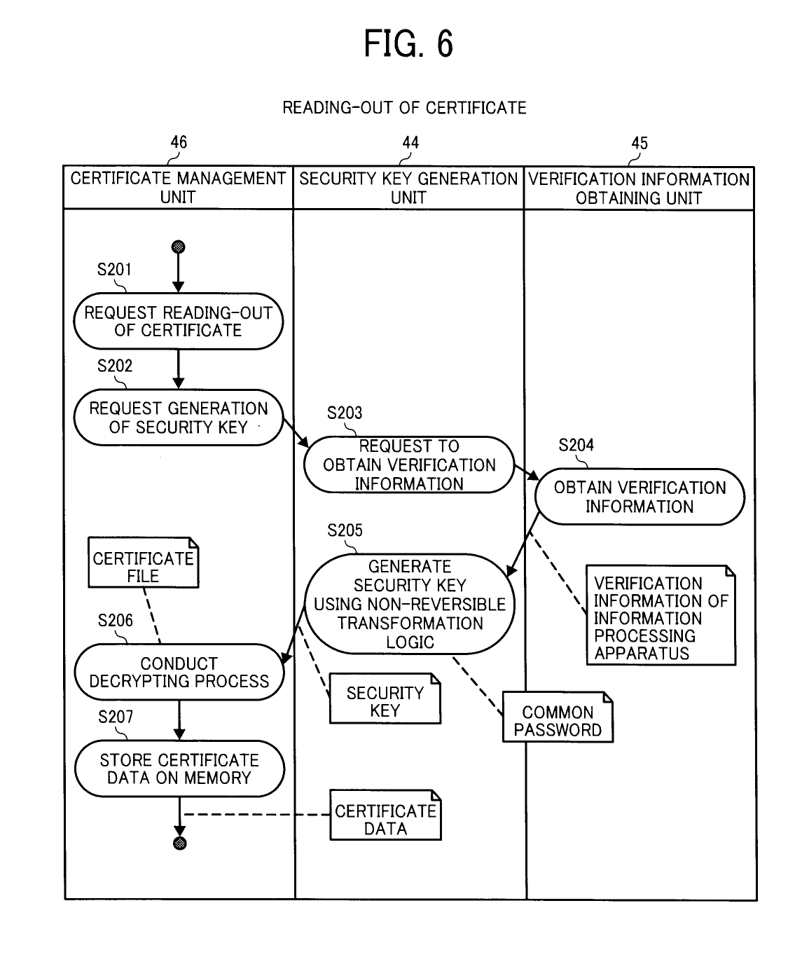

With reference to FIG. 6, a description is given to a reading-out process of certificate file generated and registered in the above described registration process for certificate file.

At step S201, the certificate management unit 46 receives a request of reading-out of certificate file from the communication unit 42, for example. Then, at step S202, the certificate management unit 46 requests a generation of security key, to be used for decrypting the certificate file, to the security key generation unit 44.

As similar to the above described registration process of certificate file, the security key generation unit 44 and the verification information obtaining unit 45 generate a security key to be transmitted to the certificate management unit 46 (steps S203 to S205).

At step S203, when the security key generation unit 44 receives a request of generation of security key from the certificate management unit 46, the security key generation unit 44 requests the verification information obtaining unit 45 to obtain verification information of the information processing apparatus JS.

At step S204, the verification information obtaining unit 45 obtains verification information of the information processing apparatus JS, and then transmits the obtained verification information of the information processing apparatus JS to the security key generation unit 44.

At step S205, the security key generation unit 44 generates a security key using non-reversible transformation logic. Specifically, after receiving the verification information of the information processing apparatus JS from the verification information obtaining unit 45, the security key generation unit 44 conducts a scramble process to the verification information used as source data by applying non-reversible transformation logic (e.g., hash function, SHA-2), and generates a security key, which may be referred to as non-reversible transformation.

As above mentioned, in the registration process, the certificate file can be encrypted with a security key generated by using the common password and the verification information of the information processing apparatus JS as source data. When such certificate file is to be read in the reading-out process, the security key generation unit 44 generates a security key using the common password and the verification information of the information processing apparatus JS.

At step S206, the security key generation unit 44 transmits the generated security key to the certificate management unit 46, and the certificate management unit 46 conducts a decrypting process for the certificate file stored in the HDD 25 using the received security key. At step S207, the decrypted certificate file is set and stored in the memory unit 26 as certificate data.

Then, a unit or the like (e.g., communication unit 42), which requests a reading-out of certificate request, retrieves the certificate data from the memory unit 26 and then conducts a required verification process.

As above described, in an example embodiment, in the information processing apparatus JS, source data useable for generating a security key may not change, by which same security key can be generated at each time the security key is required. Accordingly, a security key can be generated on the memory unit 26 when the security key is required, and when an encrypting or decrypting of certificate file using the security key has completed, the security key can be deleted from the memory unit 26. Accordingly, the certificate management unit 46 may not need to manage a security key using a file, registry, database (DB) or the like when a registration process and reading-out process for certificate file is conducted. Specifically, a request of generating a security key is requested to the security key generation unit 44 for each time a security key is required, and when an encrypting or decrypting process using the security key completed, the security key generation unit 44 can delete the security key from the memory unit 26. As such when a security key generation is requested, the security key generation unit 44 generates a security key on the memory unit 26, and when a cancel of security key is requested, the security key generation unit 44 deletes the security key generated on the memory unit 26.

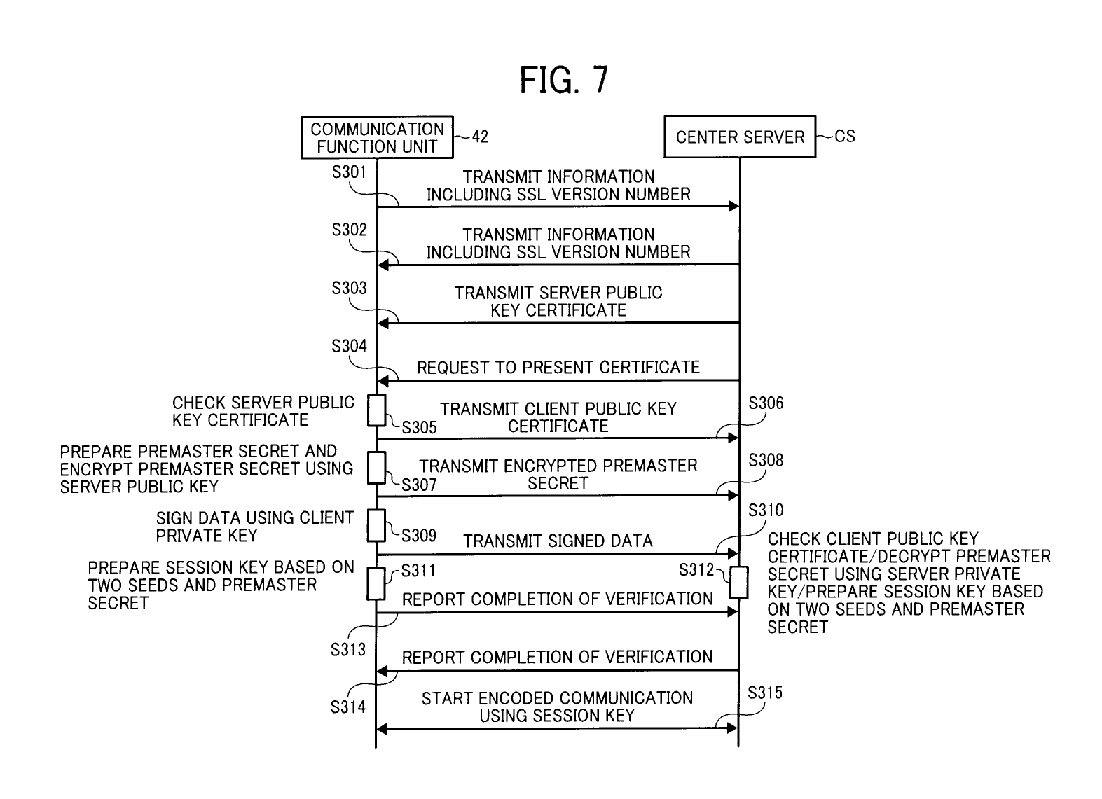

As above described, when an encryption communication for mutual authentication is conducted between the information processing apparatus JS and the center server CS, the information processing apparatus JS conducts a registration process of the discrete certification package 10, and encrypting and decrypting process for certificate data. The information processing apparatus JS may conduct a verification process by secure socket layer (SSL) using the discrete certification package 10 as illustrated in FIG. 7, for example. Further, when such verification process by SSL using the discrete certification package 10 is conducted, the center server CS, a counterpart (communication) apparatus of the information processing apparatus JS, may need to be set and use a discrete certification package as similar to the discrete certification package 10 set and used in the information processing apparatus JS.

In the apparatus monitoring system 1 according to a first example embodiment, the center server CS is stored with a specific certification package in advance. Such certification package may include a public key certificate (server public key certificate) specifically set for each one of center server CS, a private key (server private key) specifically set for each one of center server CS, and a public key certificate of the certificate authority server CAS.

When the apparatus information notification program 40 of the information processing apparatus JS is activated, and the discrete certification package 10 is set to the information processing apparatus JS, the communication unit 42 can transmit apparatus management information such as apparatus monitoring information collected by the apparatus information collecting unit 43 to the center server CS. Therefore, a security key is generated when the information processing apparatus JS conducts data communications with the center server CS (used as a counterpart apparatus) using the mutual authentication, and a security key is also generated when the center server CS conducts data communications with the information processing apparatus JS (used as a counterpart apparatus) using the mutual authentication.

When communication between the information processing apparatus JS and the center server CS is set to an allowable condition, the communication unit 42 and the center server CS may conduct communication by conducting a mutual authentication using the discrete certification package 10. In example embodiments, data communications for mutual authentication may use SSL communication.

A description is given to communication between the communication unit 42 of the information processing apparatus JS and the center server CS using a mutual authentication with reference to FIG. 7. As illustrated in FIG. 7, when communication using mutual authentication is started, the communication unit 42 transmits information such as secure socket layer (SSL) version number, encrypting set and random number usable for SSL, to the center server CS (step S301).

The center server CS transmits information such as SSL version number, usable encrypting set, and random number to the communication unit 42 of the information processing apparatus JS (step S302). Then, the center server CS transmits a server public key certificate to the communication unit 42 (step S303). The center server CS further requests the communication unit 42 to present a certificate, and waits a reply from the communication unit 42 (step S304).

When the communication unit 42 receives the server public key certificate from the center server CS, the information processing apparatus JS checks the server public key certificate, transmitted from the center server CS, using the CA public key certificate 12 of the discrete certification package 10 (step S305). If validity of the server public key certificate is confirmed (step S305), the communication unit 42 transmits the client public key certificate 11 of the discrete certification package 10 to the center server CS (step S306). Then, the communication unit 42 encrypts a premaster secret (or random number) computed from hash value of data that has been communicated with the center server CS until this step using the server public key received from the center server CS (step S307). The data that has been communicated with the center server CS until step 307 may include information related to SLL protocol, for example. Then, the communication unit 42 transmits the encrypted premaster secret to the center server CS (step S308).

Further, as for random number data computed from data that has been communicated with the center server CS until this step, signing to such random number data is conducted using the client private key 13 of the discrete certification package 10 (step S309). The data that has been communicated with the center server CS until step 308 may be SSL version information, encrypting set for SSL, random number, server certificate, or client certificate, or the like, which may be used alone or in combination.

The communication unit 42 of the information processing apparatus JS transmits the signed random number data to the center server CS (step S310). Then, the communication unit 42 prepares a session key based on seed information (e.g., two seeds) and the premaster secret (step S311).

The center server CS checks the received client public key certificate 11 using a certificate authority (CA) public key certificate set for the center server CS, and checks the signed data using the client public key certificate 11. Further, the center server CS prepares a session key based on premaster secret and seed information (e.g., two seeds), in which the premaster secret is decrypted by a server private key (step S312).

Then, the communication unit 42 transmits a message of “data will be transmitted using this session key (or common key) from now on” and a message of “SSL verification completion” to the center server CS (step S313). Similarly, the center server CS transmits a message of “data will be transmitted using this session key (or common key) from now on” and a message of “SSL verification completion” to the communication unit 42 (step S314). Then, an encryption communication using the session key is started (step S315). The communication unit 42 transmits information such as apparatus monitoring information to the center server CS using such encryption communication,

Therefore, in FIG. 7, if the information processing apparatus JS is not set with a valid discrete certification package, the information processing apparatus JS cannot present a client public key certificate having valid authority in return to a request of presentation of certificate from the center server CS. In such situation, the information processing apparatus JS is denied by the verification process, by which the information processing apparatus JS is not allowed for connecting communications with the center server CS, and thereby communications between the information processing apparatus JS and the center server CS cannot be established.

On one hand, if the center server CS is a counterfeit server, which does not belong to a true owner of discrete certification package, such counterfeit server does not have a valid server key (server private key), by which the counterfeit server cannot decrypt the premaster secret transmitted from the communication unit 42. Further, if the communication unit 42 is a counterfeit client, which does not belong to a true owner of discrete certification package 10, the center server CS cannot confirm the client public key certificate transmitted at step S306. When such situation occurs, communications between apparatuses can be stopped because such communications cannot be authorized, which means unauthorized communications or non-valid communications is denied effectively, by which a mutual authentication can be effectively conducted by denying non-valid communications.

As such, in example embodiment, the information processing apparatus JS may conduct data communications with the center server CS via the network NW using a mutual authentication and certificate file. In such process, verification information of the information processing apparatus JS, which can identify the information processing apparatus JS uniquely as physical entity, can be obtained. The obtained verification information can be used as source data to generate a security key usable for encrypting and decrypting the certificate file. Specifically, the security key can be generated by conducting “non-reversible transformation” process to the obtained verification information.

As such, a security key usable for encrypting a certificate file can be generated from verification information of information processing apparatus (used as source data) by conducting the non-reversible transformation process. Accordingly, a certificate that can be used for mutual authentication of data communications can be generated while securing communication security and user-friendliness and utility of data.

As such, a security key usable for encrypting and decrypting a certificate file can be generated by conducting the non-reversible transformation process to verification information of information processing apparatus, in which it can be prevented that source data (i.e., verification information) becomes open to public or third parties. As such, communication security can be enhanced while enhancing user-friendliness and utility of data.

Further, a security key can be generated from verification information (used as source data) of information processing apparatus (e.g., 1st apparatus), which can identify the information processing apparatus uniquely as physical entity. Accordingly, even if other information processing apparatus (e.g., 2nd apparatus) may copy and use a certificate file of 1st apparatus, it is too difficult for the 2nd apparatus to access the certificate, by which communication security can be enhanced. Further, a certificate leak or spoofing can be effectively prevented even when a certificate file is stored in the HDD 25.

As for the information processing apparatus JS, the verification information obtaining unit 45 may obtain at least one of following verification information as source data to generate a security key. Such verification information may be a media access control (MAC) address of the information processing apparatus JS on the network NW; and a serial number of the CPU 21 and a serial number of devices such as memory unit 26 installed in the information processing apparatus JS, but not limited thereto. Therefore, verification information that can identify the information processing apparatus JS uniquely as physical entity can be obtained effectively and simple manner, by which communication security and user-friendliness and utility of data can be further enhanced.

Further, as for the information processing apparatus JS, the verification information obtaining unit 45 may obtain the above described verification information of the information processing apparatus JS and a common password that is usable both for the information processing apparatus JS and the center server CS, and the security key generation unit 44 generates a security key using the common password and the verification information as source data.

Therefore, while enhancing user-friendliness and utility of data, it becomes harder to deduce an origin of a source data used for generating the security key, by which data security of certificate file can be further enhanced.

Further, as for the information processing apparatus JS, the security key generation unit 44 generates the security key on the memory unit 26 when the certificate management unit 46 requests generation of security key, wherein the security key is to be used for encrypting or decrypting a certificate file. When the encrypting or decrypting using the security key is completed, the certificate management unit 46 requests a cancellation of security key, by which the security key generation unit 44 can delete the security key from the memory unit 26.

Therefore, it is not required to keep one security key for an indefinite time duration, by which stealing of security key can be prevented more effectively, and thereby data security of certificate file can be further enhanced.

Further, the information processing apparatus JS is connected to a plurality of monitored apparatuses (e.g., monitored apparatus KK) each other via the local network LN, wherein the monitored apparatus KK is monitored for its operation status or the like. Further, the information processing apparatus JS is connected to the center server CS via the network NW, wherein the center server CS may manage the monitored-apparatus KK. Such information processing apparatus JS may collect monitoring/management information from the monitored apparatus KK via the local network LN, and transmits the monitoring/management information to the center server CS using communication under mutual authentication, wherein the monitoring/management information may be used for managing condition of the monitored-apparatus KK.

Therefore, in the apparatus monitoring system 1, the center server CS can monitor the monitored-apparatus KK by interposing the information processing apparatus JS, by which data security of certificate file can be enhanced, by which information leak such as spoofing or falsification can be effectively prevented.

In the above described example embodiment, the information processing apparatus JS may generate a security key. However, a security key can be generated using the center server CS, and the above-described effect can be similarly attained when the center server CS generates the security key.

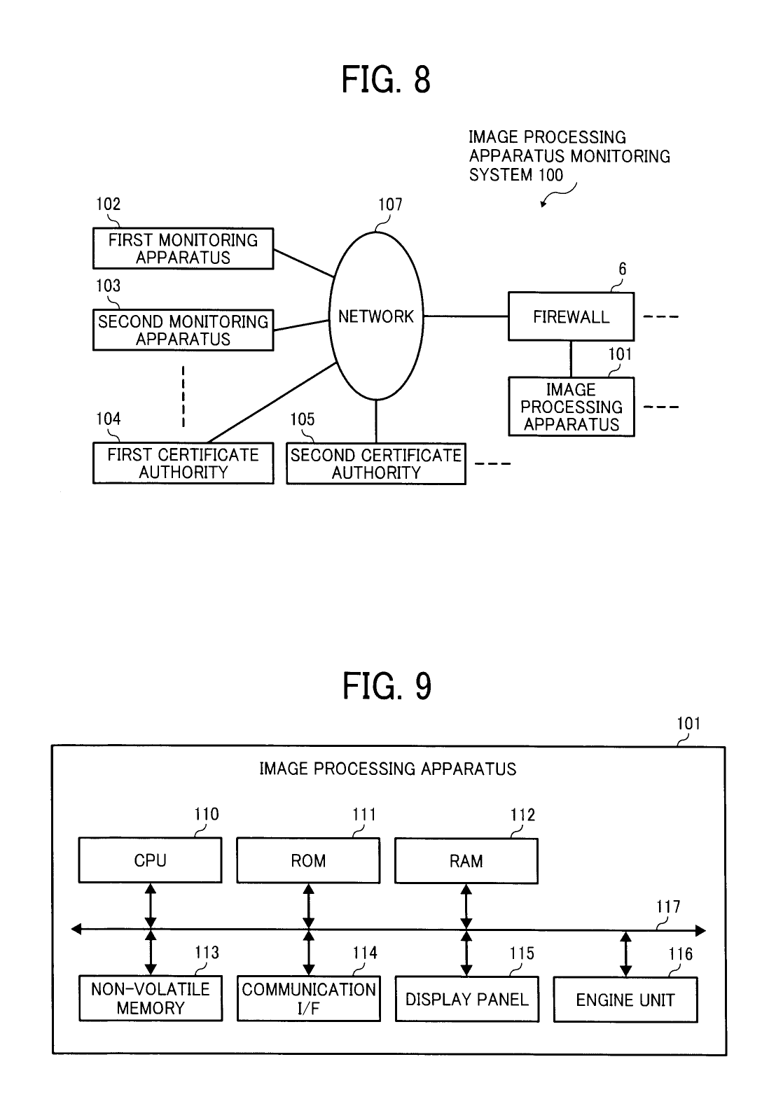

A description is now given to a second example embodiment with reference to FIGS. 8 to 18. FIG. 8 illustrates an example configuration of an image processing apparatus monitoring system 100, which can be used as information processing system according to a second example embodiment.

The image processing apparatus monitoring system 100 may be configured with an image processing apparatus 101 (used as a information processing apparatus), a first monitoring apparatus 102, a second monitoring apparatus 103, a first certificate authority 104 (first CA 104), a second certificate authority 105 (second CA 105), and a firewall 106, which may be connected to each other via a network 107 such as the Internet. As indicated by dotted line in FIG. 8, still another image processing apparatus, another firewall, another managing apparatus, another certificate authority (CA) can be included in the image processing apparatus monitoring system 100. The image processing apparatus monitoring system 100 may be referred to as “monitoring system 100,” hereinafter.

The image processing apparatus 101 may be connected to the firewall 106 via a network such as wired-type network and wireless-type network including a local area network.

Further, the firewall 106, the first monitoring apparatus 102, the second monitoring apparatus 103, the first certificate authority 104 (first CA 104), and the second certificate authority 105 (second CA 105) may be communicably connected to each other via the network 107 such as wired-type network and wireless-type network including the Internet.

Further, the image processing apparatus 101 may be connected to the network 107 via the firewall 106, by which the image processing apparatus 101 can communicate with the first monitoring apparatus 102, the second monitoring apparatus 103, the first CA 104, and the second CA 105. The image processing apparatus 101 and the firewall 106 may be located in a user site such as office. The number of user site may be one or more sites. The image processing apparatus 101 may be an image forming apparatus such as a facsimile machine, a printer, a scanner, a copier, and a multi-functional peripherals, for example. The image processing apparatus 101 may be monitored in the monitoring system 100 as a monitoring-in-progress information processing apparatus.

The image processing apparatus 101 may collect its information related to counter value of each counter unit and operating conditions using a program installed in the image processing apparatus 101, for example. Such information may be referred to as “apparatus information” which may be used for monitoring the image processing apparatus 101. The image processing apparatus 101 may transfer the apparatus information to the first monitoring apparatus 102 or the second monitoring apparatus 103 using an encryption communication such as for example secure socket layer (SSL, registered trademark) communication. The encryption communication may be conducted using a digital certificate issued by the first CA 104 or second CA 105.

The SSL, developed by Netscape Communications (registered trademark), is a protocol used for transmitting/receiving encrypted or encrypted information on the Internet. When data is used with World Wide Web (WWW) or File Transfer Protocol (FTP) on the Internet, data may be encrypted or encrypted by the SSL. With such encrypted or encrypted process, private information, credit card number, trade secret of companies, or the like can be transmitted/received in a secured manner.

The first monitoring apparatus 102 and the second monitoring apparatus 103 may be located in a monitoring site such as for example a site of apparatus manufacturer, maintenance service provider, or the like. Typically, the monitoring system 100 may be operable as below. The first monitoring apparatus 102 and the second monitoring apparatus 103 receive, accumulate, and store apparatus information from the image processing apparatus 101. Based on such apparatus information, an apparatus monitoring service can be provided for the image processing apparatus 101. As such, the first monitoring apparatus 102 and the second monitoring apparatus 103 may be used as information processing apparatus including a computer.

Further, before such apparatus monitoring service is to be provided and operated by the image processing apparatus 101, the first monitoring apparatus 102 and/or the second monitoring apparatus 103 may function as an intermediary between the image processing apparatus 101 and the first CA 104 and/or the second CA 105 to secure security of data communications between the image processing apparatus 101 and the first monitoring apparatus 102 and/or the second monitoring apparatus 103.

Specifically, the first monitoring apparatus 102 and/or the second monitoring apparatus 103 request an issuance of “discrete certification package” to the first CA 104 and/or the second CA 105 when the image processing apparatus 101 requests such issuance of discrete certification package. The discrete certification package may include data including a client private key set for the image processing apparatus 101 and public key certificate such as client public key certificate and certificate authority public key certificate. Such discrete certification package is prepared for each one of apparatuses specifically to identify each one of apparatuses.

The first monitoring apparatus 102 and/or the second monitoring apparatus 103 receive a discrete certification package issued by the first CA 104 and/or the second CA 105, and then transfer the discrete certification package to the image processing apparatus 101. Such discrete certification package may be used for establishing communications between the image processing apparatus 101 and first monitoring apparatus 102 (or the second monitoring apparatus 103) by mutual authentication method using encryption communication. After establishing communications by conducting the mutual authentication method, the image processing apparatus 101 may transfer apparatus information to the first monitoring apparatus 102 or the second monitoring apparatus 103.

Further, the discrete certification package may be prepared as digital certificate package using Public Key Cryptography Standards (PKCS, registered trademark), for example. The PKCS, developed by RSA Data Security, Inc. (registered trademark), includes various standards prepared for public key system. Some of PKCS is used in RFC, and used as one standard for the Internet.

The first CA 104 and the second CA 105 may be used as certificate authority. The first CA 104 and the second CA 105 may be devised as an information processing apparatus including a computer. The first CA 104 and the second CA 105 may issue and manage discrete certification package such as digital certificate for the image processing apparatus 101, wherein such digital certificate may be used as an electronic identification usable in the monitoring system 100.

In a second example embodiment, the first CA 104 and the second CA 105 may secure “uniqueness” of discrete certification package. Further, the first CA 104 and the second CA 105 may prevent an issuance of discrete certification package to a client apparatus (i.e., image processing apparatus), which is not verified with the first monitoring apparatus 102 and/or the second monitoring apparatus 103 (used as server).

The first CA 104 and the second CA 105 may be used as different certificate authorities, by which the first CA 104 and the second CA 105 can issue digital certificate issued in different manner. The first monitoring apparatus 102 may retain or store a digital certificate issued by the first CA 104, and the second monitoring apparatus 103 may retain or store a digital certificate issued by the second CA 105, for example. As such, the monitoring system 100 may include a function or system of issuing digital certificate.

A description is given to a hardware configuration of the image processing apparatus 101 with reference to FIG. 9. The image processing apparatus 101 may include a central processing unit (CPU) 110, a read only memory (ROM) 111, a random access memory (RAM) 112, a non-volatile memory 113, a communication interface 114 (communication I/F 114), a display panel 115, and an engine unit 116, which are connected each other using a system bus 117.

The CPU 110 (or control unit) controls the image processing apparatus 101 as a whole. The CPU 110 implements functions such as image processing functions according to example embodiments by executing programs stored in the ROM 111 or the non-volatile memory 113.

The ROM 111 may be an involatile storage, which stores programs executable by the CPU 110, and data including fixed parameters. The ROM 111 may be configured as a re-writable storage, by which programs and data including fixed parameters can be updated. The RAM 112 may be used as a storage, which stores data temporarily used, and may be used as a working memory of the CPU 110. The non-volatile memory 113 may be a re-writable involatile storage such as for example flash memory, hard disk drive (HDD). The non-volatile memory 113 stores programs executable by the CPU 110 and data such as parameters, which must be retained when power of the image processing apparatus 101 is set to OFF. The non-volatile memory 113 may also store a digital certificate used as a discrete certification package of the image processing apparatus 101. The communication I/F 114 may be a network interface to connect the image processing apparatus 101 to the network 107. For example, the communication I/F 114 may be used with Ethernet (registered trademark) communication.

When the image processing apparatus 101 communicates with other apparatuses such as first monitoring apparatus 102, the second monitoring apparatus 103, the first CA 104, and the second CA 105 via the network 107, the communication I/F 114 and the CPU 110 may function as a communication unit. Further, the communication I/F 114 may be selectively used in view of network standard, and communication protocol. Further, in the image processing apparatus 101, a plurality of communication I/Fs can be set for a plurality of communication standards.

The display panel 115 may be used an input unit and display unit, which may include a liquid crystal display (LCD) and a light emitting diode (LED), for example. The display panel 115 may display a graphical user interface (GUI), which may be used by a user to input operating information to the image processing apparatus 101. The display panel 115 may display messages and operating status of the image processing apparatus 101. Instead of the display panel 115, the image processing apparatus 101 can use an external display unit.

The engine unit 116 may be used when to input and output data between the image processing apparatus 101 and other external apparatus. For example, when a printing operation is conducted, the engine unit 116 output print data to a printer, for example.

When the image processing apparatus 101 is used as a multi-functional peripherals (MFP), the engine unit 116 may be a scanner engine to scan document image as image data, and a print engine to form images on sheets using electrophotography, for example. The CPU 110 controls the engine unit 116 to execute a reliable image input/output process for the image processing apparatus 101. The MFP is an image processing apparatus, which can perform a plurality of functions such as a printer, a scanner, a copier, and a facsimile, with one machine, for example. The engine unit 116 may not be used when data input/output process (e.g., printing of print data) is not conducted.

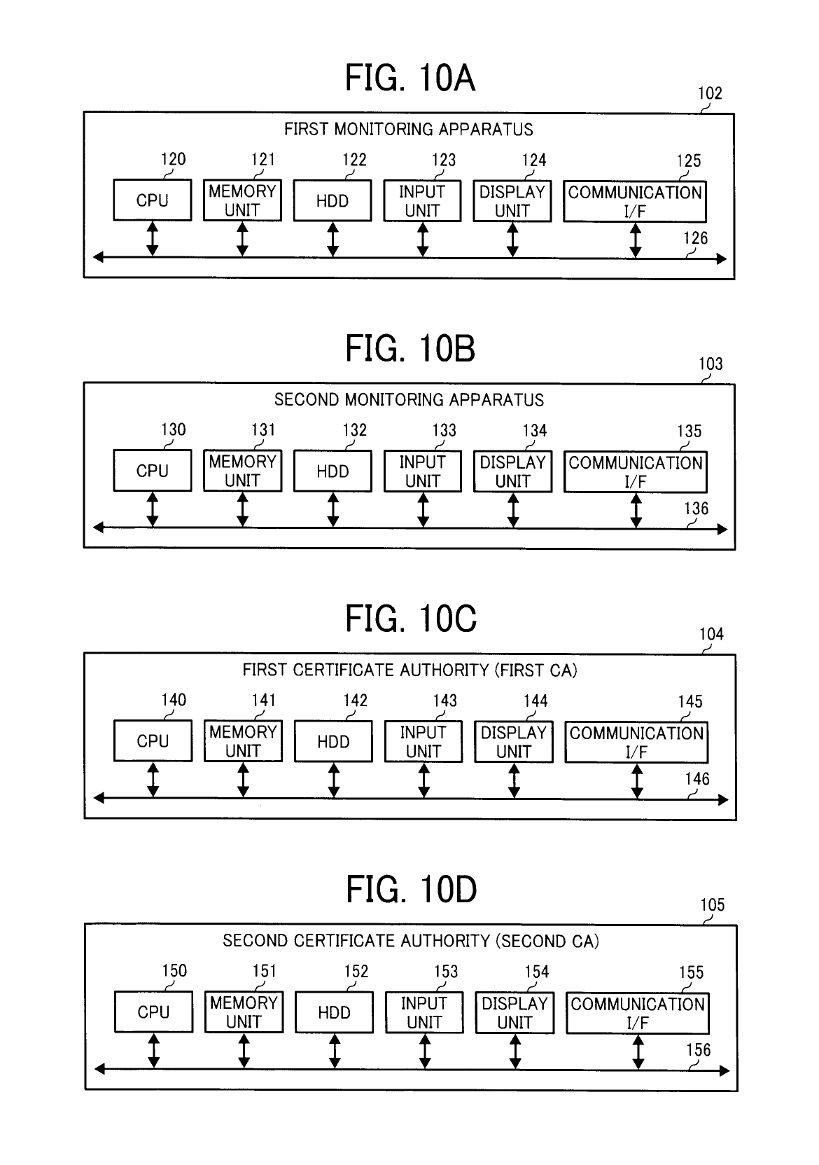

A description is given to a hardware configuration for the first monitoring apparatus 102, the second monitoring apparatus 103, the first CA 104, and the second CA 105 according to a second example embodiment with reference to FIG. 10.

As illustrated in FIG. 10A, the first monitoring apparatus 102 may include a CPU 120, a memory unit 121, a hard disk drive (HDD) 122, an input unit 123, a display unit 124, and a communication interface (I/F) 125 (used as an interface unit) connected to each other by a bus 126.

Further, as illustrated in FIG. 10B, the second monitoring apparatus 103 may include a CPU 130, a memory unit 131, a HDD 132, an input unit 133, a display unit 134, and a communication I/F 135 (used as an interface unit) connected to each other by a bus 136.

The CPU 120 of first monitoring apparatus 102 implements one or more functions executable by the first monitoring apparatus 102 using programs stored in the memory unit 121.

The HDD 122 may be used as a storage unit to store programs installed in the first monitoring apparatus 102, file data, and other data. The HDD 122 may store an image processing program to implement one or more functions according to a second example embodiment in the first monitoring apparatus 102, for example.

Such program can be read out from the HDD 122 when an activation command of program is issued, then loaded in the memory unit 121, and then the CPU 120 can execute the program.

Further, the HDD 122 may store a digital certificate transmittable to the image processing apparatus 101 and map information, to be described later.

The input unit 123 may be an input unit such as a keyboard and a mouse, which can be used by a user for inputting operation information, for example.

The display unit 124 may display a graphical user interface (GUI) using a program, and may display information under a control of the CPU 120.

The communication I/F 125 is used as an interface connectable to the network 107.

The second monitoring apparatus 103 has a similar hardware configuration of the first monitoring apparatus 102. The CPU 130 of the second monitoring apparatus 103 implements one or more functions executable by the second monitoring apparatus 103 using programs stored in the memory unit 131.

The HDD 132 may be used as a storage unit to store programs installed in second monitoring apparatus 103, file data, and other data. The HDD 132 may store an image processing program to implement one or more functions according to a second example embodiment in the second monitoring apparatus 103, for example.

Such program can be read out from the HDD 132 when an activation command of program is issued, then loaded in the memory unit 131, and then the CPU 130 can execute the program.

Further, the HDD 132 may store a digital certificate transmittable to the image processing apparatus 101 and map information, to be described later.

The input unit 133 may be an input unit such as a keyboard and a mouse, which can be used by a user for inputting operation information, for example.

The display unit 134 may display a graphical user interface (GUI) using a program, and may display information under a control of the CPU 130.

The communication I/F 135 is used as an interface connectable to the network 107.

Further, the first CA 104 has a similar hardware configuration of the first monitoring apparatus 102 and the second monitoring apparatus 103. As illustrated in FIG. 10C, the first CA 104 may include a CPU 140, a memory unit 141, a HDD 142, an input unit 143, a display unit 144 and a communication I/F 145 (used as an interface unit) connected to each other by a bus 146.

Further, as illustrated in FIG. 10D, the second CA 105 may include a CPU 150, a memory unit 151, a HDD 152, an input unit 153, a display unit 154, and a communication I/F 155 (used as an interface unit), connected to each other by a bus 156.

The CPU 140 of first CA 104 implements one or more functions executable by the first CA 104 using programs stored in the memory unit 141.

The HDD 142 may be used as a storage unit to store programs installed in the first CA 104, file data, and other data. The HDD 142 may store an image processing program to implement one or more functions according to a second example embodiment in the first CA 104, for example. Such program can be read out from the HDD 142 when an activation command of program is issued, then loaded in the memory unit 141, and then the CPU 140 can execute the program.

The input unit 143 may be an input unit such as a keyboard and a mouse, which can be used by a user for inputting operation information, for example.

The display unit 144 may display a graphical user interface (GUI) using a program, and may display information under a control of the CPU 140.

The communication I/F 145 is used as an interface connectable to the network 107.

The second CA 105 has a similar hardware configuration of the first CA 104. The CPU 150 of second CA 105 implements one or more functions executable by the second CA 105 using programs stored in the memory unit 151.

The HDD 152 may be used as a storage unit to store programs installed in the second CA 105, file data, and other data. The HDD 142 may store an image processing program to implement one or more functions according to a second example embodiment in the second CA 105, for example. Such program can be read out from the HDD 152 when an activation command of program is issued, then loaded in the memory unit 151, and then the CPU 150 can execute the program.

The input unit 153 may be an input unit such as a keyboard and a mouse, which can be used by a user for inputting operation information, for example.

The display unit 154 may display a graphical user interface (GUI) using a program, and display information under a control of the CPU 150.

The communication I/F 155 is used as an interface connectable to the network 107.

The image processing apparatus 101, the first monitoring apparatus 102, the second monitoring apparatus 103, the first CA 104, and the second CA 105 may conduct a given information processing according to a second example embodiment using information processing program stored in a storage medium, which is readable by a computer. The storage medium may be ROM, electrically erasable and programmable read only memory (EEPROM), erasable programmable ROM (EPROM), flash memory, flexible disk, compact disc read only memory (CD-ROM), compact disc rewritable (CD-RW), digital video disk (DVD), secure digital (SD) card, magneto-optical disc (MO), and or the like. The information processing program, which is a computer executable program, may be described with any languages such as legacy programming language or object-oriented programming language such as assembler, C, C++, C#, Java (registered trademark). The information processing program, stored in the above-described storage medium, can be distributed to a given apparatus or the like. Further, the information processing program according to a second example embodiment can be installed from a terminal apparatus, disposed on the network 107, to the image processing apparatus 101, the first monitoring apparatus 102, the second monitoring apparatus 103, the first CA 104, and the second CA 105, for example.

Further, the first monitoring apparatus 102, the second monitoring apparatus 103, the first CA 104, and the second CA 105 may not need to be provided or connected to a display unit and an input unit. Further, the first monitoring apparatus 102, the second monitoring apparatus 103, the first CA 104, and the second CA 105 may employ other configurations of known computer, as required.

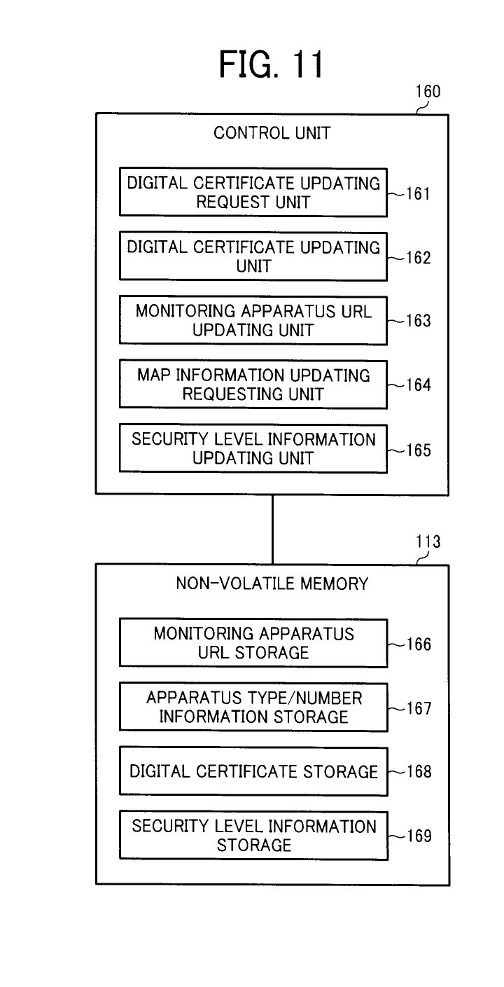

FIG. 11 illustrates a functional block diagram in a control unit 160 and the non-volatile memory 113 of the image processing apparatus 101 illustrated in FIG. 9.

The control unit 160 of the image processing apparatus 101 may include the CPU 110, the ROM 111, and the RAM 112, for example. When the CPU 110 executes a program according to a second example embodiment stored in the ROM 111 or the non-volatile memory 113, a digital certificate updating request unit 161, a digital certificate updating unit 162, a management apparatus URL updating unit 163, a map information updating requesting unit 164, and a security level information updating unit 165 may be configured in the control unit 160 so that the control unit 160 can execute one or more functions according to a second example embodiment.

Further, a management apparatus URL storage 166, an apparatus type/number information storage 167, a digital certificate storage 168, and a security level information storage 169 may be configured for the non-volatile memory 113.

The digital certificate updating request unit 161 can request the first monitoring apparatus 102 or the second monitoring apparatus 103 to update a digital certificate to a new one. For example, when the image processing apparatus 101 is being monitored using the first monitoring apparatus 102, the digital certificate updating request unit 161 may transmit apparatus type/serial number information of the image processing apparatus 101, stored in the apparatus type/number information storage 167, and the digital certificate updating request to the first monitoring apparatus 102 based on the digital certificate issued by the first CA 104. When such process is conducted, the image processing apparatus 101 may receive a new digital certificate via the first monitoring apparatus 102. Specifically, a new digital certificate issued by the second CA 105, and management apparatus URL information of the second monitoring apparatus 103 corresponding to the newly issued digital certificate may be transmitted to the first monitoring apparatus 102, and then transferred to the image processing apparatus 101. Then, the second monitoring apparatus 103 may be used as a new management apparatus to monitor the image processing apparatus 101 based on the newly issued digital certificate.

The uniform resource locator (URL) designates information of or access destination such as place, which indicates an “address” of apparatus on the Internet. Accordingly, addresses of the image processing apparatus 101, the first monitoring apparatus 102, the second monitoring apparatus 103, the first CA 104, and the second CA 105 on the Internet can be designated using URL, and address of given information (e.g., document, image data) on the Internet can be also designated using URL. In a second example embodiment, information of the first monitoring apparatus 102 and the second monitoring apparatus 103 on the network 107 may be set using URL. For example, a server name, a port number, a folder name, and a file name may be used to set URL.

The digital certificate updating unit 162 may overwrite information to update the digital certificate stored in the digital certificate storage 168 with a new digital certificate obtained by the digital certificate updating request. For example, the digital certificate updating unit 162 can update the digital certificate issued by the first CA 104 and stored in the digital certificate storage 168 with a new digital certificate issued by the second CA 105.

The management apparatus URL updating unit 163 may overwrite information to update the management apparatus URL information stored in the management apparatus URL storage 166 with a new management apparatus URL information corresponding to the new digital certificate obtained by the digital certificate updating request. For example, management apparatus URL updating unit 163 may update the management apparatus URL information of the first monitoring apparatus 102 stored in the management apparatus URL storage 166 with the management apparatus URL information of the second monitoring apparatus 103.

The map information updating requesting unit 164 requests an updating of map information to the first monitoring apparatus 102 or the second monitoring apparatus 103. For example, when the image processing apparatus 101 is being monitored using the first monitoring apparatus 102 based on the digital certificate issued by the first CA 104, the map information updating requesting unit 164 may transmit apparatus type/serial number information of the image processing apparatus 101, stored in the apparatus type/number information storage 167, URL information of the second CA 105 which can issue the new digital certificate, and a request of updating map information of the first monitoring apparatus 102 to the first monitoring apparatus 102. With such process, the map information updating requesting unit 164 may overwrite map information of the first monitoring apparatus 102. For example, the map information updating requesting unit 164 may overwrite information to update map information of the first monitoring apparatus 102. In such updating, access destination information (e.g., URL) of certificate authority may be updated from the first CA 104 to the second CA 105. In a second example embodiment, the first CA 104 may be used to issue the digital certificate corresponding to apparatus type/serial number information of the image processing apparatus 101, and the second CA 105 may be used to issue the new digital certificate, for example. The first CA 104 and the second CA 105 may have different access destination information (e.g., URL) each other.

The security level information updating unit 165, which can be activated using a user interface of the display panel 115, may update security level information stored in the security level information storage 169, for example. Based on such updating of security level information, the image processing apparatus 101 may transmit the above described updating request of map information to the first and second monitoring apparatuses 102 and/or 103. The security level information updating unit 165 may be used as a security level changing unit to change security level information, and the security level information storage 169 may be used as a storage to store security level information. The CPU 110 may be used as a transmission unit to transmit a updating request of map information based on changes of the security level information.

Further, the image processing apparatus 101 may use SSL for transmission of the above described digital certificate updating request, updating request of map information, and the above-described apparatus information to the first monitoring apparatus 102 or the second monitoring apparatus 103. In such transmission, the image processing apparatus 101 may use a digital certificate retained or stored in the image processing apparatus 101 as client certificate for SSL. Further, the image processing apparatus 101 may select a to-be-accessed monitoring apparatus (e.g., first and second monitoring apparatuses 102 and 103) based on the above described management apparatus URL information.

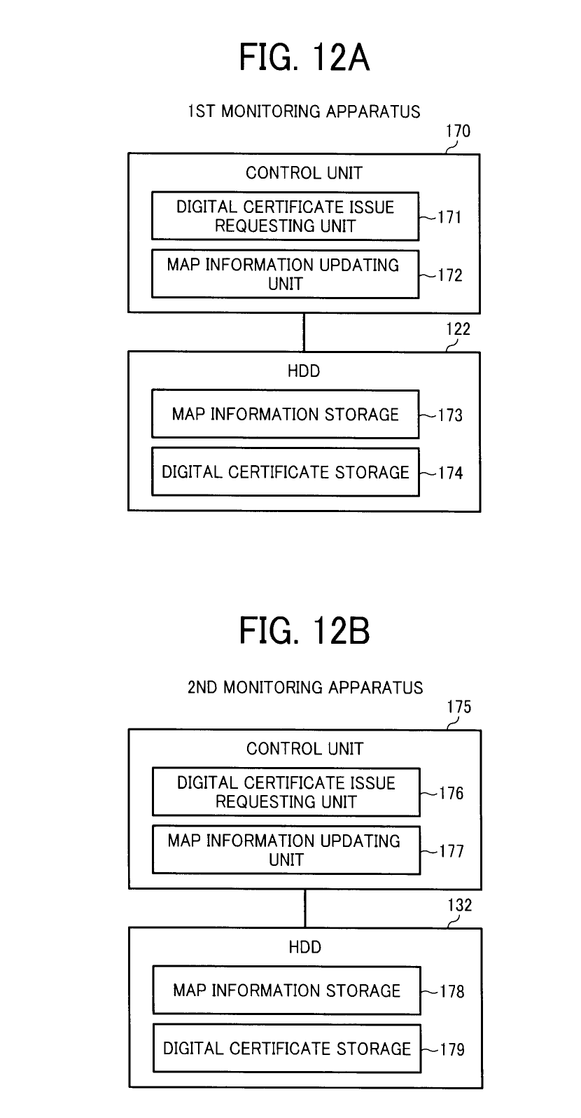

FIG. 12 illustrates a functional block diagram of a control unit of the monitoring apparatuses 102 and 103 illustrated in FIG. 10.

In the first monitoring apparatus 102, the CPU 120 and the memory unit 121 may configure a control unit 170 as illustrated in FIG. 12A. The CPU 120 may execute a program stored in the memory unit 121 to implement one or more functions according to a second example embodiment. Specifically, a digital certificate issue requesting unit 171 and a map information updating unit 172 may be configured in the control unit 170, and a map information storage 173 and a digital certificate storage 174 may be configured in the HDD 122. The information updating unit 172 may function as a map information changing unit to change map information retained or stored in the first monitoring apparatus 102.

When the digital certificate issue requesting unit 171 receives the digital certificate issuance request from the image processing apparatus 101, the digital certificate issue requesting unit 171 may select any one of the first and second CAs 104 and 105 based on apparatus type/serial number information received from the image processing apparatus 101 and map information retained or stored in the first monitoring apparatus 102. In a second example embodiment, before the map information is overwritten, the first CA 104 is selected, and thereby the digital certificate issue requesting unit 171 transmits the digital certificate issue request to the first CA 104. Then, the digital certificate issue requesting unit 171 receives the digital certificate and management apparatus URL information of the first monitoring apparatus 102 from the first CA 104. The digital certificate issue requesting unit 171 stores the digital certificate and the management apparatus URL information to the digital certificate storage 174, and transmits the digital certificate and the management apparatus URL information to the image processing apparatus 101.

Further, after overwriting map information, the digital certificate issue requesting unit 171 selects the second CA 105, and transmits the digital certificate issue request to the second CA 105. Then, the digital certificate issue requesting unit 171 receives a new digital certificate and new management apparatus URL information from the second CA 105, and the digital certificate issue requesting unit 171 stores the new the digital certificate and new management apparatus URL information in the digital certificate storage 174, and transmits the new the digital certificate and new management apparatus URL information to the image processing apparatus 101.

When the map information updating unit 172 receives an updating request of map information from the image processing apparatus 101, the map information updating unit 172 updates the map information stored in the map information storage 173. For example, when a certificate authority is changed, based on apparatus type/serial number information received from the image processing apparatus 101 and URL of changed certificate authority (e.g., second CA 105), which is access destination information, the map information updating unit 172 overwrites and updates the map information stored in the map information storage 173.

Further, as similar to the first monitoring apparatus 102, in the second monitoring apparatus 103, the CPU 130 and the memory unit 131 may configure a control unit 175 illustrated in FIG. 12B. The CPU 130 may execute a program stored in the memory unit 131 to implement one or more functions according to a second example embodiment. Specifically, a digital certificate issue requesting unit 176 and a map information updating unit 177 may be configured in the control unit 175, and a map information storage 178 and a digital certificate storage 179 may be configured in the HDD 132.

When the digital certificate issue requesting unit 176 receives the digital certificate issuance request from the image processing apparatus 101, the digital certificate issue requesting unit 176 transmits the digital certificate issue request to any one of the first and second CAs 104 and 105 based on apparatus type/serial number information received from the image processing apparatus 101 and map information retained or stored in the second monitoring apparatus 103. Then, the digital certificate issue requesting unit 176 receives a new digital certificate and new management apparatus URL information from one of the first and second CAs 104 and 105. The digital certificate issue requesting unit 176 stores the new digital certificate and new management apparatus URL information in the digital certificate storage 179, and transmits the new digital certificate and new management apparatus URL information to the image processing apparatus 101.

When the map information updating unit 177 receives a updating request of map information from the image processing apparatus 101, the map information updating unit 177 overwrites and updates the map information in the map information storage 178 based on apparatus type/serial number information received from the image processing apparatus 101 and URL of one of the first and second CAs 104 and 105.

Further, the digital certificate issue requesting unit 176 may use SSL for transmission and reception of the above described digital certificate issue request, updating request of map information, and management apparatus URL information. In such communications, the first monitoring apparatus 102 and the second monitoring apparatus 103 may respectively use the digital certificate retained or stored in the first monitoring apparatus 102 and the second monitoring apparatus 103 as client certificate for SSL communication.

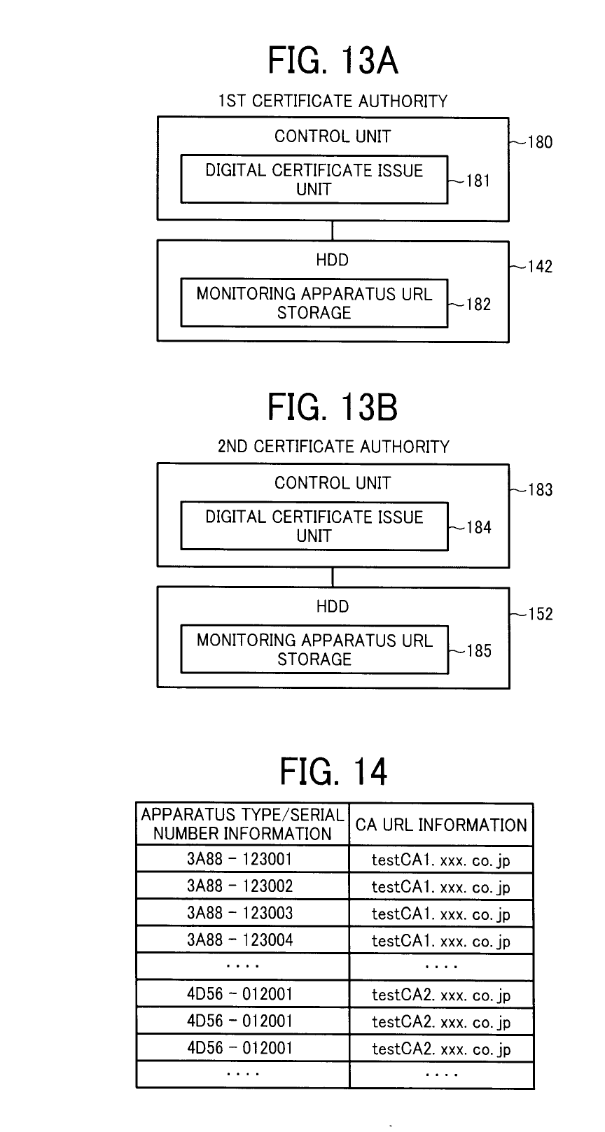

FIG. 13 illustrates a functional block diagram of the first CA 104 and the second CA 105 illustrated in FIG. 10.

In the first CA 104, the CPU 140 and the memory unit 141 may configure a control unit 180 as illustrated in FIG. 13A. When the CPU 140 executes a program stored in the memory unit 141, a digital certificate issue unit 181 may be configured in the control unit 180, and a management apparatus URL storage 182 may be configured in the HDD 142.

When the digital certificate issue unit 181 receives the digital certificate issue request from the first monitoring apparatus 102, the digital certificate issue unit 181 issues a new digital certificate. Then, the digital certificate issue unit 181 reads out management apparatus URL information of the first monitoring apparatus 102 from the management apparatus URL storage 182, wherein the digital certificate issued by the digital certificate issue unit 181 may be set to be used with the first monitoring apparatus 102 used as management apparatus. Then, the digital certificate issue unit 181 transmits the digital certificate and the management apparatus URL information of the first monitoring apparatus 102 to the first monitoring apparatus 102.

The management apparatus URL storage 182 may store management apparatus URL information of the first monitoring apparatus 102. The first monitoring apparatus 102 may monitor communications of the image processing apparatus 101 using SSL communication and the digital certificate issued by the first CA 104.

As similar to the first CA 104, in the second CA 105, the CPU 150 and the memory unit 151 may configure a control unit 183 as illustrated in FIG. 13B. When the CPU 150 executes a program stored in the memory unit 151, a digital certificate issue unit 184 may be configured in the control unit 183, and a management apparatus URL storage 185 may be configured in the HDD 152.

When the digital certificate issue unit 184 receives the digital certificate issue request from the first monitoring apparatus 102, the digital certificate issue unit 184 issues a new digital certificate. Then, the digital certificate issue unit 184 reads out management apparatus URL information of the second monitoring apparatus 103 from the management apparatus URL storage 185, wherein the digital certificate issued by the digital certificate issue unit 184 may be set to be used with the second monitoring apparatus 103 used as management apparatus. Then, the digital certificate issue unit 184 transmits the digital certificate and the management apparatus URL information of the second monitoring apparatus 103 to the first monitoring apparatus 102.

The management apparatus URL storage 185 may store management apparatus URL information of the second monitoring apparatus 103. The second monitoring apparatus 103 may monitor communications of the image processing apparatus 101 using SSL communication and the digital certificate issued by the second CA 105.

FIG. 14 illustrates example map information in a second example embodiment, wherein map information may retain or store data with a given configuration.

The first monitoring apparatus 102 and the second monitoring apparatus 103 may retain or store map information of a plurality of image processing apparatuses (e.g., image processing apparatus 101) connected to the network 107. Such plurality of image processing apparatuses not illustrated in drawings may be also referred to as image processing apparatus 101, hereinafter, for the sake of simplifying expression.

The map information may include apparatus type/serial number information of plurality of image processing apparatuses (i.e., image processing apparatus 101), and “CA URL information” of a plurality of certificate authorities (e.g., first CA 104, second CA 105), wherein the apparatus type/serial number information and CA URL information may be correlated as illustrated in FIG. 14 as map information. Each of the plurality of certificate authorities (e.g., first CA 104, second CA 105) may issue a digital certificate to the corresponding image processing apparatus 101. The map information may be managed by the first monitoring apparatus 102 and the second monitoring apparatus 103, for example.

For example, when the first monitoring apparatus 102 receives a digital certificate updating request from the image processing apparatus 101, based on apparatus type/serial number information of the image processing apparatus 101, which is received with the digital certificate updating request, the first monitoring apparatus 102 refers to the map information retained or stored in the first monitoring apparatus 102. Then, the first monitoring apparatus 102 obtains new CA URL information of CA corresponding to the apparatus type/serial number information of the image processing apparatus 101 from the map information. For example, CA URL information of second CA 105 may be obtained as new CA URL information for the image processing apparatus 101. Such CA URL information may be used as access destination information. Based on the new CA URL information, the first monitoring apparatus 102 selects the second CA 105 as an access destination, and accesses the second CA 105. Then, the first monitoring apparatus 102 instructs a digital certificate issue request to the second CA 105.

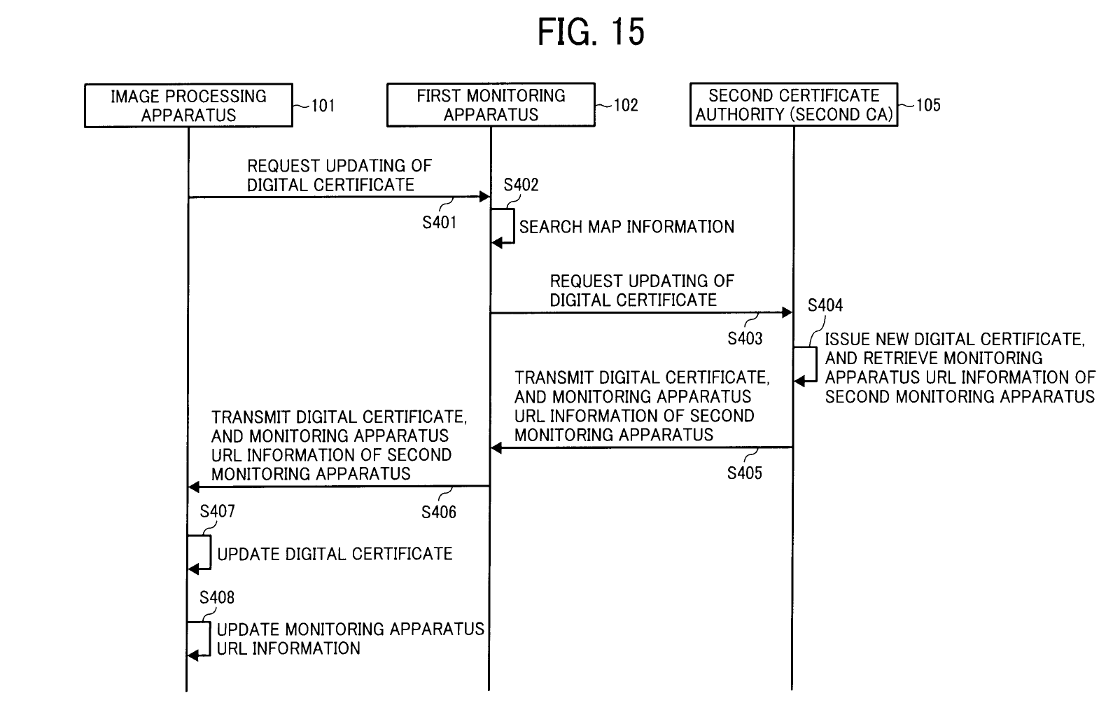

A description is now given to a digital certificate updating process in the monitoring system 100 according to a second example embodiment with reference to FIG. 15.

FIG. 15 illustrates a sequential chart for digital certificate updating process in the monitoring system 100. In a process of illustrated in FIG. 15, it is assumed that the image processing apparatus 101 and the first monitoring apparatus 102 communicate with each other using SSL and a digital certificate issued by the first CA 104.

In the digital certificate updating process illustrated in FIG. 15, a digital certificate issued by the first CA 104 and stored in the image processing apparatus 101 can be updated with a new digital certificate issued by the second CA 105, and management apparatus URL information can be also updated from the URL of first monitoring apparatus 102 to the URL of second monitoring apparatus 103. After such digital certificate updating process, the image processing apparatus 101 and the second monitoring apparatus 103 start to communicate with each other using SSL and a new digital certificate issued by the second CA 105.

Further, in the monitoring system 100, the first CA 104 may issue a digital certificate having a shorter key length, and the second CA 105 may issue a digital certificate having a longer key length. In such configuration, when the digital certificate of the image processing apparatus 101 is updated from the digital certificate issued by the first CA 104 to the digital certificate issued by the second CA 105, security level for data communications can be enhanced. For example, the image processing apparatus 101 and the first monitoring apparatus 102 may conduct a SSL communication using the digital certificate issued by the first CA 104 whereas the image processing apparatus 101 and the second monitoring apparatus 103 may conduct a SSL communication using a new digital certificate issued by the second CA 105. When comparing such two communications, data communications of the image processing apparatus 101 and the second monitoring apparatus 103 using the digital certificate issued by the second CA 105 can enhance security level compared to data communications of the image processing apparatus 101 and the first monitoring apparatus 102 using the digital certificate issued by the first CA 104.

As illustrated in FIG. 15, the control unit 160 of the image processing apparatus 101 transmits a digital certificate updating request with apparatus type/serial number information of the image processing apparatus 101 to the first monitoring apparatus 102 (step S401). As such, the control unit 160 of the image processing apparatus 101 may function as a transmission unit to send updating contents and updating request for map information.

Based on the apparatus type/serial number information received from the image processing apparatus 101 with the digital certificate updating request, the control unit 170 of the first monitoring apparatus 102 searches map information retained or stored in the first monitoring apparatus 102 to confirm “CA URL information” corresponding to the apparatus type/serial number information of the image processing apparatus 101 (step S402), in which URL information of the second CA 105 may be checked and confirmed at step S402, for example.

Based on the confirmed CA URL information (e.g., URL information of second CA 105), the control unit 170 of the first monitoring apparatus 102 accesses the second CA 105, and transmits a digital certificate issue request to the second CA 105 (step S403).

When the control unit 180 of second CA 105 receives the digital certificate issue request from the first monitoring apparatus 102, the control unit 180 issues a new digital certificate, and retrieves management apparatus URL information retained or stored in the second CA 105 (step S404).

Such management apparatus URL information may include URL information of the monitoring apparatuses (e.g., first and second monitoring apparatuses 102 and 103), which may monitor SSL communication using the digital certificate issued by the second CA 105. In a second example embodiment, the management apparatus URL information of the second monitoring apparatus 103 may be used as management apparatus URL information at step S404.

The control unit 183 of the second CA 105 transmits the issued digital certificate and the retrieved management apparatus URL information to the first monitoring apparatus 102 (step S405).

The control unit 170 of first monitoring apparatus 102 receives the issued digital certificate and the retrieved management apparatus URL information from the second CA 105, and then transmits the issued digital certificate and the retrieved management apparatus URL information to the image processing apparatus 101 (step S406).

The control unit 160 of the image processing apparatus 101 receives the new digital certificate and the management apparatus URL information from the first monitoring apparatus 102. Based on the new digital certificate and the management apparatus URL information received from the first monitoring apparatus 102, the control unit 160 updates digital certificate and management apparatus URL information set for the image processing apparatus 101 (steps S407 and S408).

After conducting such process, the image processing apparatus 101 and the second monitoring apparatus 103 can conduct a SSL communication using the digital certificate issued by the second CA 105.

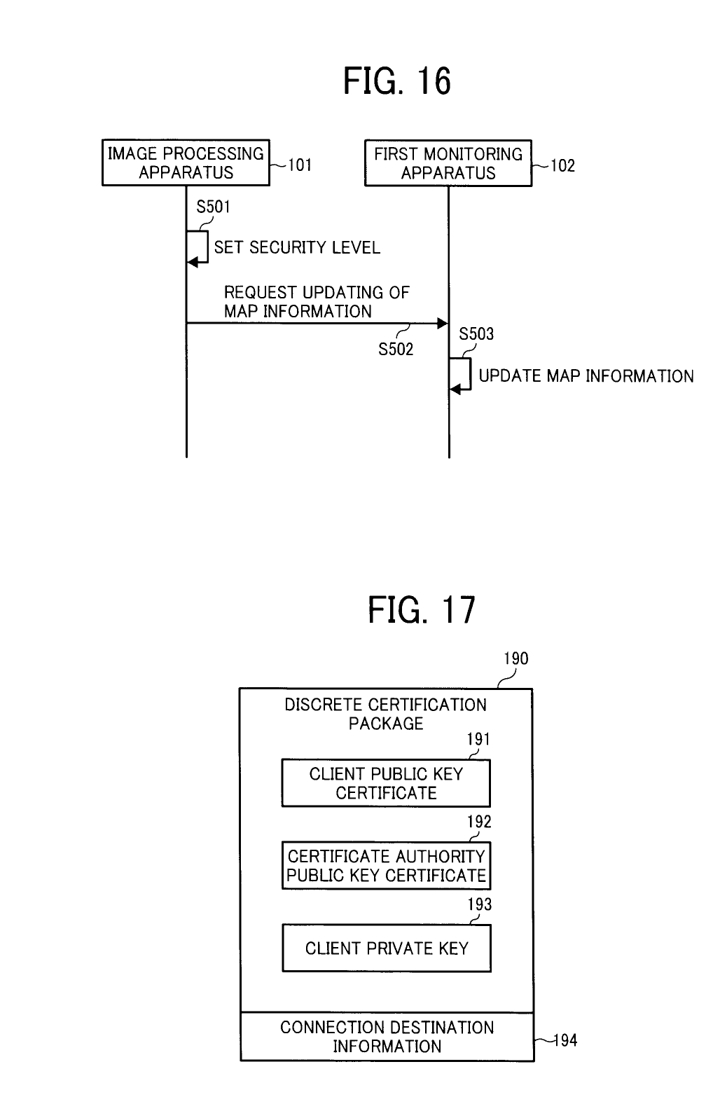

A description is given to a map information updating process in the monitoring system 100 according to a second example embodiment with reference to FIG. 16, which illustrates a sequential chart for map information updating process in the monitoring system 100.

As above described, the first CA 104 may issue a digital certificate having a shorter key length, and the second CA 105 may issue a digital certificate having a longer key length. By implementing the digital certificate updating process illustrated in FIG. 15, security level of data communications between the image processing apparatus 101 and the second monitoring apparatus 103 can be enhanced.

Accordingly, security level of data communications can be enhanced by updating map information retained or stored in the first monitoring apparatus 102. Specifically, by updating URL information of certificate authority corresponded to apparatus type/serial number information of image processing apparatus 101 from the URL of first CA 104 to the URL of second CA 105, the digital certificate can be updated, by which the security level of communication can be enhanced resultantly. For example, security level information can be set using a user interface provided for the display panel 115 of the image processing apparatus 101. Such security level information may be referred to security strength level, security level classification such as high/middle/low, for example.

As illustrated in FIG. 16, in the image processing apparatus 101, based on an instruction of security level setting (e.g., change from middle level to high level) input by using the user interface, the control unit 160 of the image processing apparatus 101 may set a given security level (step S501).

When the security level is changed to enhanced level (i.e., higher security level) as above described, the URL of the certificate authority is changed and input to the control unit 160 of the image processing apparatus 101. For example, in the process of FIG. 16, the URL of the second CA 105 that can issue a digital certificate enhancing security level is input to the control unit 160 of the image processing apparatus 101, and then the control unit 160 of the image processing apparatus 101 transmits a updating request of map information with apparatus type/serial number information of the image processing apparatus 101 and the URL information of the second CA 105 to the first monitoring apparatus 102 (step S502). As such, the control unit 160 may function as a transmission unit to transmit an updating request and updating contents for map information of the management apparatus

Further, the control unit 160 of the image processing apparatus 101 may conduct such transmission at step 502 in a different manner. For example, the image processing apparatus 101 may be devised to store URL information of first and second CAs 104 and 105 in a memory in advance. When given URL information of CA is input to the image processing apparatus 101 under such configuration, such input URL information of CA may be automatically read out from the memory, which means URL of any one of the first and second CAs 104 and 105 corresponding to the changed security level can be read, and such URL information of any one of the first and second CAs 104 and 105 can be also used at step 502.

The control unit 170 of the first monitoring apparatus 102 receives the apparatus type/serial number information of the image processing apparatus 101 and the URL information of the second CA 105 (as updating contents) with the updating request of map information from the image processing apparatus 101. Then, the first monitoring apparatus 102 overwrites the map information stored in the first monitoring apparatus 102 to update the map information. Specifically, the first monitoring apparatus 102 overwrites new CA URL information (i.e., URL information of second CA 105) received from the image processing apparatus 101 on the previous CA URL information so that the map information stored in the first monitoring apparatus 102 can be updated (step S503). In such process, the CPU 120 may be used as a revising unit to revise the map information of the first monitoring apparatus 102 (used as management apparatus) based on updating contents received with an updating request of map information from the image processing apparatus 101, for example.

Further, in such map information updating process, map information can be updated using an input value input by the input unit 123 of the first monitoring apparatus 102.

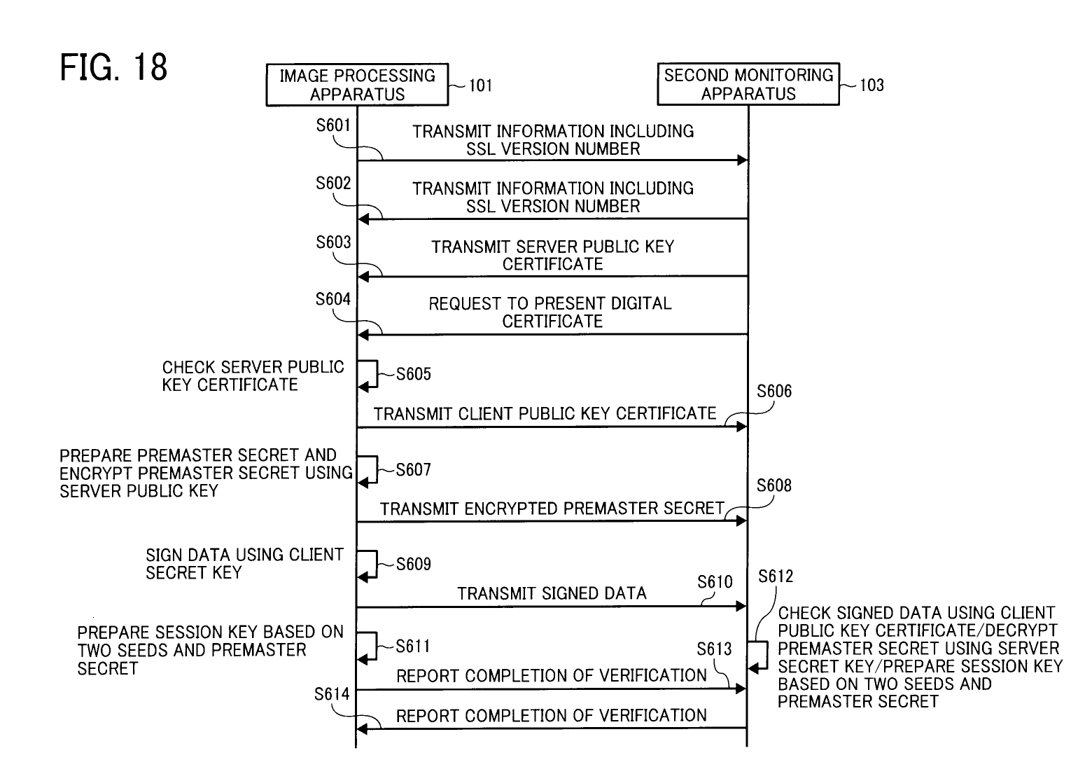

A description is given to a verification process using SSL (hereinafter, SSL verification process) in the monitoring system 100 according to a second example embodiment with reference to FIG. 17 and FIG. 18.

FIG. 17 illustrates an example discrete certification package usable for SSL verification process between the image processing apparatus 101 and a monitoring apparatus such as the second monitoring apparatus 103, for example.

The image processing apparatus 101 may retain or store a discrete certification package 190 as the digital certificate as illustrated in FIG. 17. The discrete certification package 190 may include a client public key certificate 191, a certificate authority (CA) public key certificate 192, a client private key 193, and connection destination information 194, for example.

The client public key certificate 191 and the client private key 193 may be respectively used as a public key certificate and a private key for the image processing apparatus 101 when the image processing apparatus 101 conducts mutual authentication using encryption communication with a monitoring apparatus such as first monitoring apparatus 102, second monitoring apparatus 103, or the like.

The CA public key certificate 192 may be used as a public key certificate issue-able by the first CA 104 and the second CA 105.

The connection destination information 194 is used as identification information of connection destination when an encryption communication using the discrete certification package 190 is conducted. For example, the connection destination information 194 may be URL of monitoring apparatus such as first monitoring apparatus 102, second monitoring apparatus 103, or the like.

FIG. 18 illustrates a sequential chart for a verification process between the image processing apparatus 101 and the second monitoring apparatus 103 using SSL communication and discrete certification package.

Further, in such SSL-based verification process, as similar to the image processing apparatus 101 that retains a discrete certification package, the second monitoring apparatus 103 may also need to be set with a discrete certification package. Accordingly, a specific discrete certification package may be already set and stored in the second monitoring apparatus 103.

Such discrete certification package may include a specific public key certificate, a specific private key set for each monitoring apparatus, and a public key certificate issued by a certificate authority. For example, the specific public key certificate (e.g., server public key certificate) may be set for each of the first and second monitoring apparatuses 102 and 103; the specific private key (e.g., server private key) may be set for each of the first and second monitoring apparatuses 102 and 103; and the public key certificate may be issued by each of the first and second CAs 104 and 105. In following description, the second CA 105 may be used as a CA to issue a certificate.

In FIG. 18, the image processing apparatus 101 may be used as a client apparatus for communication apparatus conducting data communications, for example. The image processing apparatus 101 may transmit information such as SSL version number, encrypting set usable for SSL, and random number to the second monitoring apparatus 103 when data communications is started (step S601).

When the second monitoring apparatus 103 receives such information, the second monitoring apparatus 103 transmits information such as SSL version number, to-be-used encrypting set, and random number, to the image processing apparatus 101 (step S602).

The second monitoring apparatus 103 transmits a server public key certificate to the image processing apparatus 101 (step S603). Further, the second monitoring apparatus 103 requests the image processing apparatus 101 to present a digital certificate (step S604), and waits a reply from the image processing apparatus 101.

When the image processing apparatus 101 receives the server public key certificate from the second monitoring apparatus 103, the image processing apparatus 101 checks validity of the server public key certificate using a CA public key certificate set for the image processing apparatus 101 (step S605).

If it is confirmed that the server public key certificate is valid, the image processing apparatus 101 transmits a client public key certificate to the second monitoring apparatus 103 (step S606).

Then, the image processing apparatus 101 prepares a premaster secret (or random number) computed from hash value of data that has been communicated with the second monitoring apparatus 103 until this step, and encrypts the premaster secret using the server public key (step S607).

Then, the image processing apparatus 101 transmits the encrypted premaster secret to the second monitoring apparatus 103 (step S608).

Further, as for random number data computed from data that has been communicated with the second monitoring apparatus 103 until this step, the image processing apparatus 101 signs the random number data using the client private key (step S609). Then, the image processing apparatus 101 transmits the signed random number data to the second monitoring apparatus 103 (step S610).

Then, the image processing apparatus 101 prepares a session key based on the seed information (e.g., two seeds) and premaster secret (step S611).

The second monitoring apparatus 103 checks the client public key certificate, received from the image processing apparatus 101, using the CA public key certificate retained by the second monitoring apparatus 103. Further, the second monitoring apparatus 103 checks the signed data received from the image processing apparatus 101 using the client public key certificate. Further, the second monitoring apparatus 103 decrypts the premaster secret received from the image processing apparatus 101 using the server private key, and prepares a session key based on the decrypted premaster secret and the seed information (e.g., two seeds) (step S612).

Then, the image processing apparatus 101 may transmit a message of “data will be transmitted using this session key from now on” and a message of “SSL verification completion” to the second monitoring apparatus 103, by which the image processing apparatus 101 may report a verification completion to the second monitoring apparatus 103 (step S613).

Similarly, the second monitoring apparatus 103 may transmit a message of “data will be transmitted using this session key from now on” and a message of “SSL verification completion” to the image processing apparatus 101, by which the second monitoring apparatus 103 may report a verification completion to the image processing apparatus 101 (step S614).

Then, the image processing apparatus 101 and the second monitoring apparatus 103 starts an encryption communication using the session key, and the image processing apparatus 101 may transmit apparatus information or the like to the second monitoring apparatus 103.

Accordingly, if the image processing apparatus 101 and the second monitoring apparatus 103 may not set with valid discrete certification packages, the image processing apparatus 101 and the second monitoring apparatus 103 may be rejected by the above described verification process, and thereby subsequent communications cannot be conducted.

Accordingly, apparatus information can be transferred from the image processing apparatus 101 to the second monitoring apparatus 103 when a discrete certification package is set for each of the image processing apparatus 101 and the second monitoring apparatus 103.

Therefore, in FIG. 18, if the second monitoring apparatus 103 is a counterfeit server, which does not belong to a true owner of digital certificate, such counterfeit server does not have a valid private key, by which a premaster secret transmitted from the image processing apparatus 101 cannot be decrypted. Further, if the image processing apparatus 101 is a counterfeit client, which does not belong to a true owner of digital certificate, signed data transmitted from the client cannot be confirmed. As such, a mutual authentication can be effectively conducted by denying or rejecting non-valid communications.

In the monitoring system 100 according to a second example embodiment, the above described certification updating can be conducted for each of image processing apparatuses (i.e., image processing apparatus 101) by selectively using certificate authorities as access destination for image processing apparatuses. For example, in a second example embodiment, the first and second CAs 104 and 105 can be automatically selected as access destination when updating a certificate for each of image processing apparatuses.

In the above-described embodiments, the image processing apparatus 101 may retain a given digital certificate issued by one certificate authority therein. When the image processing apparatus 101 updates the given digital certificate to other digital certificate issued by other certificate authority, the image processing apparatus 101 may automatically change a monitoring apparatus, used as access destination. For example, when the image processing apparatus 101 updates one digital certificate issued by one certificate authority to other digital certificate issued by other certificate authority, the image processing apparatus 101 can automatically change an access destination from the first monitoring apparatus 102 to the second monitoring apparatuses 103, or from the second monitoring apparatuses 103 to the first monitoring apparatus 102.

In the above described embodiments, a security key used for encrypting a certificate file can be generated by conducting “non-reversible transformation” to verification information attached to an information processing apparatus as source data, by which a certificate which can be used in safe manner for mutual authentication of data communications can be generated while enhancing user-friendliness and utility of data. Further, in the above described embodiments, in one system including different information processing apparatuses using different certificates having different security level, it can implement an enhanced security configuration between the image processing apparatus and the management apparatus, and maintain downward compatibility of communication between apparatuses at the same time.

In the above described example embodiments, a computer-readable medium storing a program for mutual authentication between an information processing apparatus and a counterpart apparatus connected to each other via a communication network is devised. The information processing apparatus and the counterpart apparatus supporting data communications use mutual authentication using a certificate file. The program includes instructions that when executed by a computer cause the computer to execute a method of mutual authentication between the information processing apparatus and the counterpart apparatus. The method comprising a certificate management step, a verification information obtaining step, and a security key generation step. The certificate management step encrypts and decrypts the certificate file using a security key. The verification information obtaining step obtains verification information of the information processing apparatus. The verification information enables identification of the information processing apparatus as a unique physical entity. The security key generation step generates the security key by conducting a non-reversible transformation of the verification information obtained by the verification information obtaining step. The verification information is used as source data.

In the above described example embodiments, a method of information processing in an information processing system is devised. The information processing system includes one or more information processing apparatuses, one or more certificate authorities, and one or more management apparatuses. Each of the one or more information processing apparatuses, having apparatus type/serial number information, includes a communication unit that can transmit a digital certificate updating request with the apparatus type/serial number information. The one or more information processing apparatuses are disposable in the information processing system and each of the information processing apparatuses having unique apparatus type/serial number information. Each of the one or more certificate authorities issues a digital certificate. The one or more of the certificate authorities are disposable in the information processing system and each of the certificate authorities has unique access destination information. The one or more management apparatuses monitor the one or more information processing apparatuses. The one or more management apparatuses store map information correlating the apparatus type/serial number information of the one or more information processing apparatuses and the access destination information of the one or more certificate authorities for each of the information processing apparatuses and each of the certificate authorities. The one or more management apparatuses are disposable in the information processing system and each of the management apparatuses having unique access destination information. The information processing apparatuses includes an updating unit to update digital certificate information and corresponding access destination information of management apparatus stored in the information processing apparatuses. One of the one or more information processing apparatuses is monitored by a first management apparatus having a first access destination information and uses a first digital certificate issued by a first certificate authority for secure communications. The first management apparatus and the first certificate authority are set to use together. When the information processing apparatuses issues a digital certificate issue request to the first management apparatus to request an issuance of a second digital certificate for the information processing apparatuses, the method of information processing is conducted. The method includes issuing, receiving, and updating. The issuing step issues a digital certificate issue request to the first management apparatus to request an issuance of a second digital certificate for the information processing apparatuses. The receiving step receives the second digital certificate, issued by a second certificate authority, and second access destination information, set for a second management apparatus, via the first management apparatus when the digital certificate issue request is correctly executed by the first management apparatus and the second certificate authority. The second management apparatus and the second certificate authority are set to use together. The updating step updates the first digital certificate and the first access destination information of the first management apparatus stored in the information processing apparatuses to the second digital certificate and the second access destination information of the second management apparatus using the updating unit.

In the above described example embodiments, a computer-readable medium storing a program for information processing in an information processing system is devised. The program includes instructions that when executed by a computer causes the computer to execute a method of information processing in the information processing system. Each of the one or more information processing apparatuses, having apparatus type/serial number information, includes a communication unit that can transmit a digital certificate updating request with the apparatus type/serial number information. The one or more information processing apparatuses are disposable in the information processing system and each of the information processing apparatuses having unique apparatus type/serial number information. Each of the one or more certificate authorities issues a digital certificate. The one or more of the certificate authorities are disposable in the information processing system and each of the certificate authorities has unique access destination information. The one or more management apparatuses monitor the one or more information processing apparatuses. The one or more management apparatuses store map information correlating the apparatus type/serial number information of the one or more information processing apparatuses and the access destination information of the one or more certificate authorities for each of the information processing apparatuses and each of the certificate authorities. The one or more management apparatuses are disposable in the information processing system and each of the management apparatuses having unique access destination information. The information processing apparatuses includes an updating unit to update digital certificate information and corresponding access destination information of management apparatus stored in the information processing apparatuses. One of the one or more information processing apparatuses is monitored by a first management apparatus having a first access destination information and uses a first digital certificate issued by a first certificate authority for secure communications. The first management apparatus and the first certificate authority are set to use together. When the information processing apparatuses issues a digital certificate issue request to the first management apparatus to request an issuance of a second digital certificate for the information processing apparatuses, the method of information processing is conducted. The method includes issuing, receiving, and updating. The issuing step issues a digital certificate issue request to the first management apparatus to request an issuance of a second digital certificate for the information processing apparatuses. The receiving step receives the second digital certificate, issued by a second certificate authority, and second access destination information, set for a second management apparatus, via the first management apparatus when the digital certificate issue request is correctly executed by the first management apparatus and the second certificate authority. The second management apparatus and the second certificate authority are set to use together. The updating step updates the first digital certificate and the first access destination information of the first management apparatus stored in the information processing apparatuses to the second digital certificate and the second access destination information of the second management apparatus using the updating unit.

The above described example embodiments can be usefully applied for information processing apparatuses used in an apparatus monitoring system for communicating data using a mutual authentication based on a certificate file such as digital certificate. Further, the above described example embodiments can be usefully applied for method of mutual authentication, mutual authentication program, information processing system or apparatus, information processing method, information processing program, and a storage medium, for example.

In the above-described exemplary embodiments, a computer can be used with a computer-readable program to control functional units used for an information processing system or apparatus. For example, a particular computer may control the information processing apparatus and the information processing system or apparatus using a computer-readable program, which can execute the above-described processes or steps. Further, in the above-described exemplary embodiments, a storage device (or storage medium), which can store computer-readable program, may be a flexible disk, a compact disk read only memory (CD-ROM), a digital versatile disk read only memory (DVD-ROM), DVD recording only/rewritable (DVD-R/RW), a memory card, a memory chip, a mini disk (MD), magnetic tape, hard disk such in a server, or the like, but not limited these. Further, a computer-readable program can be downloaded to a particular computer (e.g., personal computer) via a network, or a computer-readable program can be installed to a particular computer from the above-mentioned storage device, by which the particular computer may be used for the information processing system or apparatus according to exemplary embodiments, for example.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information processing apparatus connected to a counterpart apparatus via a communication network, the information processing apparatus and the counterpart apparatus supporting data communications using mutual authentication using a certificate file, the information processing apparatus comprising:
a certificate management unit to encrypt and decrypt the certificate file using a security key;
a verification information obtaining unit to obtain verification information of the information processing apparatus, the verification information enabling identification of the information processing apparatus as a unique physical entity; and
a security key generation unit to generate the security key by conducting a non-reversible transformation of the verification information obtained by the verification information obtaining unit, the verification information being used as source data.

2. The information processing apparatus according to claim 1, wherein the verification information obtaining unit obtains as the verification information at least one of a media access control (MAC) address of the information processing apparatus in the communication network and a serial number of a device disposed in the information processing apparatus.

3. The information processing apparatus according to claim 1, further comprising a common password obtaining unit to obtain a common password useable with the counterpart apparatus,
wherein the security key generation unit generates the security key using the common password obtained by the common password obtaining unit and the verification information obtained by the verification information obtaining unit as the source data.

4. The information processing apparatus according to claim 1, further comprising a storage unit to store the security key generated by the security key generation unit,
wherein the certificate management unit requests the security key generation unit to generate a security key when the certificate file is encrypted or decrypted using the security key, and the certificate management unit requests the security key generation unit to cancel the security key when either the encoding or decoding using the security key is completed,
the security key generation unit generates the security key on the storage unit when the certificate management unit requests the security key, and the security key generation unit deletes the security key generated on the storage unit when the certificate management unit requests cancellation of the security key.

5. The information processing apparatus according to claim 1, wherein the information processing apparatus is connected to and monitors a plurality of apparatuses via a local network and is connected to a network provided with a management server that manages the monitored apparatuses,
the information processing apparatus collects management information from the monitored apparatuses via the local network, the collected management information useable for managing the monitored apparatuses, and
the information processing apparatus identifies the management server as the counterpart apparatus and transmits the management information to the management server using mutual authentication.

6. A method of mutual authentication between an information processing apparatus and a counterpart apparatus connected to each other via a communication network, the information processing apparatus and the counterpart apparatus supporting data communications using mutual authentication using a certificate file, the method comprising:
a certificate management step of encrypting and decrypting the certificate file using a security key;
a verification information obtaining step of obtaining verification information of the information processing apparatus, the verification information enabling identification of the information processing apparatus as a unique physical entity; and
a security key generation step of generating the security key by conducting a non-reversible transformation of the verification information obtained by the verification information obtaining step, the verification information being used as source data.

7. The method of mutual authentication according to claim 6, further comprising a common password obtaining step of obtaining a common password useable with the counterpart apparatus,
wherein the security key generation step generates the security key using the common password obtained in the common password obtaining step and the verification information obtained in the verification information obtaining step as the source data.

8. The method of mutual authentication according to claim 6, wherein the certificate management step requests the security key generation step to generate a security key when the certificate file is encrypted or decrypted using the security key, and the certificate management step requests the security key generation step to cancel the security key when either the encrypting or decrypting using the security key is completed,
the security key generation step generates the security on a storage unit of the information processing apparatus when the step of certificate management requests the security key, and the security key generation step deletes the security key generated on the storage unit when the step of certificate management requests to cancel the security key.

9. An information processing system comprising:
one or more information processing apparatuses, having apparatus type/serial number information, including a communication unit that can transmit a digital certificate updating request with the apparatus type/serial number information, the one or more information processing apparatuses disposable in the information processing system and each of the information processing apparatuses having unique apparatus type/serial number information;
one or more certificate authorities to issue a digital certificate, the one or more of the certificate authorities disposable in the information processing system and each of the certificate authorities having unique access destination information; and
one or more management apparatuses for monitoring the one or more information processing apparatuses, the one or more management apparatuses storing map information correlating the apparatus type/serial number information of the one or more information processing apparatuses and the access destination information of the one or more certificate authorities for each of the information processing apparatuses and each of the certificate authorities, the one or more management apparatuses disposable in the information processing system and each of the management apparatuses having unique access destination information,
the information processing apparatus including an updating unit to update digital certificate information and corresponding access destination information of management apparatus stored in the information processing apparatus,
wherein one of the one or more information processing apparatuses is monitored by a first management apparatus having a first access destination information and uses a first digital certificate issued by a first certificate authority for secure communications, the first management apparatus and the first certificate authority being set to use together,
when the information processing apparatus issues a digital certificate issue request to the first management apparatus to request an issuance of a second digital certificate for the information processing apparatus,
the information processing apparatus receives the second digital certificate, issued by a second certificate authority, and second access destination information, set for a second management apparatus, via the first management apparatus when the digital certificate issue request is correctly executed by the first management apparatus and the second certificate authority, the second management apparatus and the second certificate authority being set to use together, and
the updating unit of the information processing apparatus updates the first digital certificate and the first access destination information of the first management apparatus stored in the information processing apparatus to the second digital certificate and the second access destination information of the second management apparatus.

10. The information processing system according to claim 9, wherein the information processing apparatus includes a transmission unit to transmit a map information updating request and updating contents for the map information of management apparatus, and
the management apparatus includes a revising unit to revise the map information stored in the management apparatus based on the updating contents for the map information received with the map information updating request from the information processing apparatus.

11. The information processing system according to claim 10, wherein the information processing apparatus further includes:
a storage unit to store security level information set for the image processing apparatus and the management apparatus;
a security level changing unit to change the security level information; and
a transmission unit to transmit a map information updating request to the management apparatus based on changes in the security level information.

12. The information processing system according to claim 9, wherein the management apparatus include a map information changing unit to change map information stored in the management apparatus.
